(19) United States
(12) Patent Application Publication
(10) Pub. No.: US 2026/0330470 A1
(43) Pub. Date: Oct. 22, 2026

(54) ARTIFICIAL INTELLIGENCE ASSISTANT FOR CONSTRAINT-BASED RESPONSE GENERATION

(71) Applicant: Truist Bank, Charlotte, NC (US)

(72) Inventors: Alexandra Heath Misiaszek, Wake Forest, NC (US); John Briggs, Nashville, TN (US)

(73) Assignee: Truist Bank, Charlotte, NC (US)

(21) Appl. No.: 19/468,093

(22) Filed: Feb. 3, 2026

Related U.S. Application Data
(60) Provisional application No. 63/766,715, filed on Mar. 4, 2025.

(51) Int. Cl. G06Q 30/015; G06Q 10/02

(52) U.S. Cl. CPC G06Q 30/015; G06Q 10/02

(57) ABSTRACT

Methods, apparatuses, and computer-readable media for processing and responding to requests from devices about events at physical locations. A processor receives the request and employs a large language model to determine the intent behind it. Based on the identified intent and specific constraints, the LLM generates a response containing relevant information about the event. This response is then returned to the device.

### CROSS REFERENCE TO RELATED APPLICATION

This application claims priority to and benefit of U.S. Provisional Patent Application Ser. No. 63/766,715 filed on Mar. 4, 2025, entitled ARTIFICIAL INTELLIGENCE ASSISTANT FOR CONSTRAINT-BASED RESPONSE GENERATION, the entire contents of which are hereby expressly incorporated by reference.

### BACKGROUND

Accurately processing natural language presents several challenges. One challenge is ambiguity. Natural language can be ambiguous, with different meanings possible for the same words or phrases depending on the context. For example, Large Language Models (LLMs) may struggle with less common, highly nuanced, or context-dependent queries. Another challenge is the need for real-time processing. Client devices often require quick responses, necessitating a balance between model complexity, which enhances understanding, and computational efficiency, which affects response time.

Moreover, ensuring that responses are not only accurate but also relevant and useful is a challenge. Limitations in the model's training data, inconsistencies in language data, or insufficient domain-specific information can lead to inaccurate or irrelevant responses.

### BRIEF SUMMARY

Shortcomings of the prior art are overcome and additional advantages are provided through the provision of a computing system for intent-based event response generation.

In one embodiment, a method involves a processor receiving a request from a device, where the request includes details about an event at a physical location. The request is processed using a large language model to determine the intent associated with it. Based on the identified intent and any applicable constraints, the LLM generates a response with information related to the event. This response is then returned to the device by the processor.

In one embodiment, an apparatus includes a processor and a memory that stores instructions. When these instructions are executed by the processor, they enable the processor to receive a request from a device, containing an event at a physical location. The request is processed by a large language model to ascertain the intent linked to the request. The LLM generates a response based on this intent and any constraints, which contains information about the event. The processor subsequently returns this response to the device.

In one embodiment, a non-transitory computer-readable storage medium contains instructions that, when executed by a processor, cause the processor to perform specific actions. These include receiving a request from a device that describes an event at a physical location, processing the request with a large language model to determine the associated intent, generating a response from the LLM based on the intent and constraints, and returning the response to the device.

The features, functions, and advantages that have been described herein may be achieved independently in various embodiments of the present disclosure including computer-implemented methods, computer program products, and computing systems or may be combined in yet other embodiments, further details of which can be seen with reference to the following description and drawings.

### BRIEF DESCRIPTION OF THE SEVERAL VIEWS OF THE DRAWINGS

To easily identify the discussion of any particular element or act, the most significant digit or digits in a reference number refer to the figure number in which that element is first introduced.

Having thus described embodiments in general terms, reference will now be made to the accompanying drawings, wherein:

FIG. 1 illustrates an aspect of the subject matter in accordance with one embodiment.

FIG. 2 illustrates an aspect of the subject matter in accordance with one embodiment.

FIG. 3 illustrates an aspect of the subject matter in accordance with one embodiment.

FIG. 4 illustrates an aspect of the subject matter in accordance with one embodiment.

FIG. 5A illustrates an aspect of the subject matter in accordance with one embodiment.

FIG. 5B illustrates an aspect of the subject matter in accordance with one embodiment.

FIG. 6 illustrates an aspect of the subject matter in accordance with one embodiment.

FIG. 7 illustrates an aspect of the subject matter in accordance with one embodiment.

FIG. 8 illustrates an aspect of the subject matter in accordance with one embodiment.

FIG. 9 illustrates an aspect of the subject matter in accordance with one embodiment.

FIG. 10 illustrates an aspect of the subject matter in accordance with one embodiment.

FIG. 11 illustrates a logic flow 1100 in accordance with one embodiment.

FIG. 12A is a diagram of a feedforward network, according to at least one embodiment, utilized in machine learning.

FIG. 12B is a diagram of a convolutional neural network, according to at least one embodiment, utilized in machine learning.

FIG. 12C is a diagram of a portion of the convolutional neural network of FIG. 12B, according to at least one embodiment, illustrating assigned weights at connections or neurons.

FIG. 13 is a diagram representing an exemplary weighted sum computation in a node in an artificial neural network.

FIG. 14 is a diagram of a Recurrent Neural Network (RNN), according to at least one embodiment, utilized in machine learning.

FIG. 15 is a schematic logic diagram of an artificial intelligence program including a front-end and a back-end algorithm.

FIG. 16 is a flow chart representing a method, according to at least one embodiment, of model development and deployment by machine learning.

FIG. 17 illustrates a computing system 1700 in accordance with one embodiment.

### DETAILED DESCRIPTION

Embodiments disclosed herein provide advanced artificial intelligence (AI) technologies in a variety of contexts. The contexts may be associated with events at physical locations. Examples of contexts may include, but are not limited to, aiding in accessibility, enhancing user engagement, wayfinding (or navigation), and language translation. Examples of physical locations include any number and type of real-world locations, such as arenas, golf courses, stadiums, theme parks, offices, educational institutions, buildings, apartment complexes, etc. The events may include any type of event, such as sporting events, meetings, concerts, conferences, theme park visits, or any other type of event.

In some embodiments, an AI chatbot may be implemented via one or more AI models, such as a large language model, neural network, etc. In some embodiments, the AI chatbot is provided by a financial institution and is publicly available, including people who hold accounts at the financial institution and people who do not hold accounts at the financial institution. The AI chatbot may assist users in any number and type of contexts, such as the aforementioned accessibility, engagement, wayfinding, and/or language translation, as well as other types of contexts, such as general question answering.

In some embodiments, the AI chatbot may be tuned to provide assistance to users attending events at physical locations. In some embodiments, users may access the AI chatbot by scanning a matrix code that is directed to a link. When accessed by a user device, the link may launch a website that provides the AI chatbot and/or download an application that provides the chatbot. Doing so may allow the users to access the AI chatbot without requiring authentication. For example, the AI chatbot may provide information on event details, crowd densities, shuttle wait times, food options, accessible seating at an event, such as a sporting event. The AI chatbot may support multiple languages and voice inputs. By using AI models, embodiments disclosed herein improve understanding and responses, while also collecting data for engagement and prospective client insights.

The integration of AI models in the chatbot may enhance the chatbot's ability to understand varied user inputs. In some embodiments, the AI models may be trained to generate responses based on pre-approved content and set guardrails. Doing so may reduce the need for manual training of the AI chatbot, improve confidence scores for responses generated by the AI chatbot, and improve accuracy in responses generated by the AI chatbot.

In some embodiments, the AI chatbot may provide navigation assistance at a physical location, e.g., to help users find specific locations, meeting rooms, bathrooms, and other facilities through natural language understanding. In some embodiments, the AI chatbot may include a product recommendation tool to help users find the best credit card and/or product based on their criteria, providing recommendations without being invasive to the user's browsing experience.

To ensure accuracy and appropriateness, guardrails are implemented for content generation in the AI chatbot. Using enhanced AI techniques, data is ingested from a plurality of data sources. The data may be from websites, sponsors, vendors, or any data source. The data may be used to train the AI chatbot and/or be used to provide a source of information used by the AI chatbot when generating responses. Furthermore, the responses generated by the chatbot may be based on pre-approved text, concepts, data types, etc., ensuring no sensitive data is exposed in the public interactions with the AI chatbot. The AI chatbot may be retrained based on feedback, e.g., whether a response was correct, inaccurate, etc.

In some embodiments, the AI chatbot may facilitate live streaming and/or video highlights at events, increased accessibility for users with disabilities, and support for language translations (e.g., from English to Spanish, Spanish to English, etc.).

Advantageously, embodiments disclosed herein leverage advanced AI technologies to enhance user engagement, assist with accessibility needs, provide information, and generally respond to user queries. Doing so provides accurate and relevant information to users in real-time, whether at public events, private events, or via a website on the Internet. By supporting multiple languages and voice inputs, embodiments disclosed herein ensure inclusivity and ease of use for a diverse audience. The integration of AI models reduces the need for manual bot training, improves response accuracy, and enhances the overall user experience by understanding varied user inputs and generating appropriate responses.

More specifically, embodiments disclosed herein leverage data ingestion and curation processes to ensure that only relevant and appropriate information is used for training the LLM. The implementation of guardrails ensures that the generated content is accurate, appropriate, and compliant with legal and regulatory standards. Doing so may improve the performance of computing systems and/or AI-based systems, e.g., by improving the accuracy of responses and limiting the types of responses that can be generated by AI components. Embodiments are not limited in these contexts.

Aspects of the present disclosure and certain features, advantages, and details thereof are explained more fully below with reference to the non-limiting examples illustrated in the accompanying drawings. Descriptions of well-known processing techniques, systems, components, etc. are omitted so as to not unnecessarily obscure the disclosure in detail. It should be understood that the detailed description and the specific examples, while indicating aspects of the disclosure, are given by way of illustration only, and not by way of limitation. Various substitutions, modifications, additions, and/or arrangements, within the spirit and/or scope of the underlying concepts will be apparent to those skilled in the art from this disclosure. Note further that numerous aspects and features are disclosed herein, and unless inconsistent, each disclosed aspect or feature is combinable with any other disclosed aspect or feature as desired for a particular embodiment of the concepts disclosed herein.

Unless described or implied as exclusive alternatives, features throughout the drawings and descriptions should be taken as cumulative, such that features expressly associated with some particular embodiments can be combined with other embodiments. Like numbers refer to like elements throughout.

While certain exemplary embodiments have been described and shown in the accompanying drawings, it is to be understood that such embodiments are merely illustrative of, and not restrictive on, the broad disclosure, and that this disclosure not be limited to the specific constructions and arrangements shown and described, since various other changes, combinations, omissions, modifications and substitutions, in addition to those set forth in the above paragraphs, are possible. Those skilled in the art will appreciate that various adaptations, modifications, and combinations of the herein described embodiments can be configured without departing from the scope and spirit of the disclosure. Therefore, it is to be understood that, within the scope of the included claims, the disclosure may be practiced other than as specifically described herein.

Additionally, illustrative embodiments are described below using specific code, designs, architectures, protocols, layouts, schematics, or tools only as examples, and not by way of limitation. Furthermore, the illustrative embodiments are described in certain instances using particular software, tools, or data processing environments only as example for clarity of description. The illustrative embodiments can be used in conjunction with other comparable or similarly purposed structures, systems, applications, or architectures. One or more aspects of an illustrative embodiment can be implemented in hardware, software, or a combination thereof.

As understood by one skilled in the art, program code, as referred to in this application, can include both software and hardware. For example, program code in certain embodiments of the present disclosure can include fixed function hardware, while other embodiments can utilize a software-based implementation of the functionality described. Certain embodiments combine both types of program code.

The terms “coupled,” “fixed,” “attached to,” “communicatively coupled to,” “operatively coupled to,” and the like refer to both (i) direct connecting, coupling, fixing, attaching, communicatively coupling; and (ii) indirect connecting coupling, fixing, attaching, communicatively coupling via one or more intermediate components or features, unless otherwise specified herein. “Communicatively coupled to” and “operatively coupled to” can refer to physically and/or electrically related components.

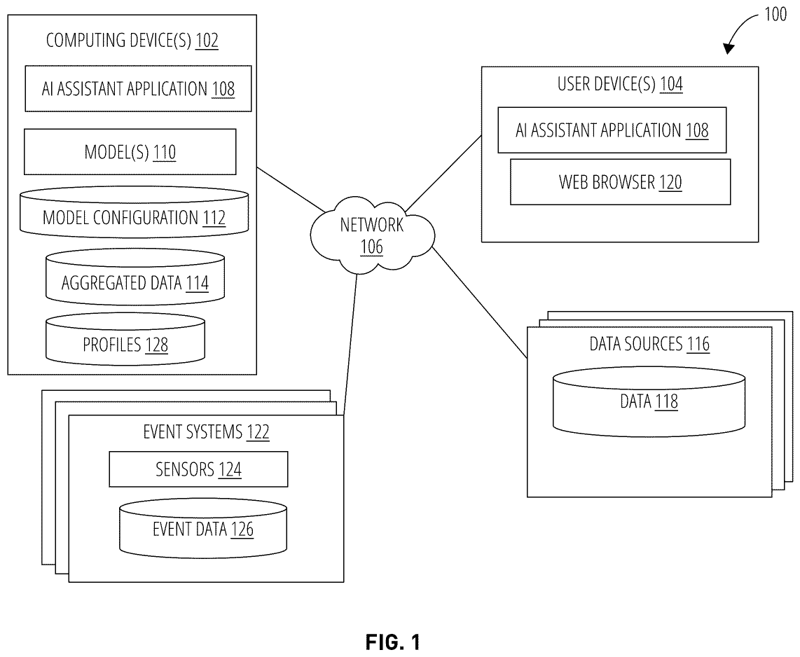

FIG. 1 illustrates a system 100 according to one embodiment. As shown, the system 100 includes one or more computing devices 102, one or more user devices 104, one or more data sources 116, and one or more event systems 122 communicably coupled via one or more networks 106. The computing devices 102, user devices 104, data sources 116, and event systems 122 are representative of any type of physical and/or virtualized computing system. The computing devices 102, user devices 104, data sources 116, and event systems 122 each include at least one processor for executing instructions and at least one memory for storing instructions, each not pictured for the sake of clarity. In some embodiments, the components of the system 100 may be spread over various geographical locations.

As shown, the computing device 102 includes an AI assistant application 108, one or more artificial intelligence models 110, a data store of model configuration 112, a data store of aggregated data 114, and a plurality of user profiles 128. The AI assistant application 108 provides an AI-based chatbot that is configured to assist users in a variety of contexts and based on a plurality of predetermined intents and/or constraints in the model configuration 112. The models 110 may be any type of AI model, such as a neural network, LLM, machine learning model, etc. In some embodiments, the AI assistant application 108 is part of a dedicated application provided by a financial institution, e.g., an account management application.

Although depicted as an application, the AI assistant application 108 and/or the models 110 may be implemented as any type of executable code, such as services, microservices, processes, AI agents, and the like. Therefore, in some embodiments, the AI assistant application 108 and/or one or more of the models 110 may collectively define at least a portion of an AI agent.

An AI agent is an autonomous system designed to perform tasks, make decisions, and adapt based on data and user feedback. An AI agent operates independently, automating processes in various fields, including the ability to generate code, communicate using natural language, etc. AI agents may operate without human intervention, making decisions and taking actions based on their programming and learning. AI agents may use machine learning algorithms to improve their performance over time by learning from data and experiences. Similarly, AI agents can perceive their environment through sensors or data inputs, allowing them to understand and interact with the world around them. Further still, AI agents may process information and make decisions based on logical reasoning, often using techniques like rule-based systems, neural networks, or probabilistic models. AI agents may communicate with humans and other systems through natural language processing, speech recognition, and other interfaces. AI agents may be designed to achieve specific goals or complete tasks, often optimizing their actions to maximize efficiency or effectiveness. Advantageously, AI agents may be scaled to handle large amounts of data and complex tasks, making them suitable for a wide range of applications.

Furthermore, the AI assistant application 108 and/or models 110 may be provided via a website and/or a dedicated application that may be downloaded, e.g., from an application store. In some embodiments, a user may scan a matrix code (e.g., a quick response (QR) code® or any other 2-dimensional code) that encodes a link (e.g., a uniform resource identifier (URI), uniform resource locator (URL), etc.). The link may be directed to the website hosting the AI assistant application 108 and/or a system where the AI assistant application 108 may be downloaded to a device such as user device 104. Therefore, in one embodiment, when user device 104 scans the matrix code, the user device 104 may access the website hosting the AI assistant application 108 using the web browser 120. In one embodiment, when user device 104 scans the matrix code, the web browser 120 or another application (e.g., an application store application) may download the AI assistant application 108 to the user device 104. Doing so makes the AI assistant application 108 publicly available to all users.

Training and configuring the models 110 involves several steps to ensure the models 110 can accurately understand and respond to user queries. The process may begin with data ingestion, where data 118 is received from various data sources 116 and event data 126 is received from event systems 122 (e.g., by the AI assistant application 108 or another application) and aggregated into the aggregated data 114. In some embodiments, the aggregated data 114 includes user preferences and/or customized options (e.g., some or all of the data in user profiles 128), and the models 110 may be trained based on the user preferences and/or customized options.

The data sources 116 may include any feasible data source, such as databases, computing systems, storage devices, social media platforms, navigation platforms (e.g., maps, location information, etc.), websites, other applications, public sites, and event-specific data (e.g., data associated with sporting events, concerts, meetings, organizations, people, etc.). The event systems 122 represent computing systems present at real-world locations, such as arenas, golf courses, stadiums, theme parks, offices, educational institutions, buildings, apartment complexes, etc. The event data 126 includes data that may be captured by the sensors 124 and/or any other type of information associated with an event at the real-world location. The sensors 124 may include any type of device, e.g., cameras, microphones, thermometers, weather stations, scoring systems, etc. Therefore, the event data 126 may include videos, audio, images, scores, temperatures, weather data, statistics, participant profiles, etc. The event data 126 and/or data 118 may further include maps, location information, etc., describing a plurality of different locations. By providing maps, location information, etc., in the event data 126 and/or data 118, the models 110 are able to provide navigation instructions from one location to one or more other locations, e.g., at arenas, golf courses, office complexes, etc.

The aggregated data 114 received from the data sources 116 and/or event systems 122 may be reviewed and/or curated to ensure that appropriate and relevant information is used for training the models 110. Doing so may maintain the quality and reliability of the responses generated by the chatbot. In some embodiments, the model configuration 112 may include a plurality of intents, which may be predefined categories of user queries that the chatbot (implemented via the models 110 and/or AI assistant application 108) is permitted to understand and respond to. Furthermore, the model configuration 112 may include guardrails that may define the boundaries of what the AI chatbot can and cannot discuss. These guardrails may ensure that the responses generated by the AI chatbot are accurate, appropriate, and compliant with legal and regulatory standards. More generally, the model configuration 112 may include a plurality of approved topics (or concepts), restricted topics, approved data types, restricted data types (e.g., sensitive information), approved responses, and/or restricted responses.

The models 110 (e.g., the AI chatbot) are then trained using the aggregated data 114 and/or the model configuration 112 (e.g., intents, guardrails, etc.) with adjustments made to the parameters of the models 110 to improve their performance. In some embodiments, the training process includes practice generations of prompts to fine-tune the ability of the models 110 to interpret user queries and generate relevant responses. In some embodiments, the training of the models 110 includes practice generations of prompts to fine-tune the performance.

In some embodiments, confidence scores, which indicate the certainty of the models 110 in their responses, are tweaked to ensure that the models 110 can accurately interpret user queries and provide reliable answers. This helps in determining the intent behind user queries more effectively. More generally, the models 110 may undergo continuous improvement based on feedback and new data. This may include retraining the models 110 with additional information and refining the guardrails and intents as needed.

In some embodiments, the models 110 include a plurality of models 110 for a plurality of different types of events and/or locations. For example, a first model 110 may be trained for golf events, a second model 110 may be trained for corporate events, a third model 110 may be trained for theme park events, and so on.

When the models 110 are trained, the models 110 may be integrated as AI chatbots into the AI assistant application 108 and/or computing devices 102, where the models 110 can generate responses based on the aggregated data 114. The responses are pre-approved and generated from a bank of information that has been reviewed and approved by the team (e.g., the model configuration 112 and/or aggregated data 114). The models 110 may use confidence scores to determine the reliability of generated responses, ensuring accurate interpretation of user queries and returning appropriate answers.

When a user submits a natural language question to the AI assistant application 108, the AI assistant application 108 may process the query using the trained model 110 (and/or models 110) to interpret the user's intent and extract relevant information. For example, the AI assistant application 108 and/or models 110 may extract one or more topics, attributes, and/or features from the question. The model 110 then generates a response based on the interpreted intent and the extracted information, ensuring that the response is accurate and relevant to the user's query. This process allows the model 110 to provide real-time information and assistance, enhancing user engagement and accessibility. By leveraging advanced AI technologies and innovative training methods, the AI assistant application 108 and/or the models 110 may deliver a reliable and user-friendly experience. Embodiments are not limited in these contexts.

For example, a financial institution providing the AI assistant application 108 may sponsor a golf event held at a golf course. In such embodiments, the golf event may have an associated entity (e.g., a golf league with a plurality of golfers), and data 118 from the websites and/or other data sources 116 associated with the golf event, league, and/or golfers may be received by the AI assistant application 108, e.g., to train the models 110 for the golf event.

At the golf course, a plurality of matrix codes may be displayed (e.g., on screens, displays, printed materials, etc.) allowing users to access the AI assistant application 108 via their user devices 104. Doing so allows the users to converse with the AI assistant application 108 using voice and/or text, in any number of languages. For example, the user may ask the AI assistant application 108 to identify accessible seating or other accommodations, translate text and/or speech in an input language to different output languages, provide directions to specific locations at the golf course, order food, find parking, or generally answer questions. As another example, the user may ask where the nearest shuttle stop is located and what the wait time for the next shuttle is, and the AI assistant application 108 may generate and return a response including directions to the nearest shuttle stop and the approximate wait time for the next 2 shuttles at the stop. As another example, the user may ask about the crowd density at a specific location (e.g., the 18th hole) and the AI assistant application 108 may determine the crowd density (e.g., based on mobile device data) and return a response such as “the 18th hole is crowded”. Furthermore, during and/or subsequent to the golf event, the AI assistant application 108 may receive real-time video and/or highlights from the event systems 122. Doing so allows users to view video of the event, highlights of the event, etc., via the user devices 104.

In some embodiments, the AI assistant application 108 and/or models 110 may generate recommendations and/or incentives to customers. For example, the AI assistant application 108 and/or models 110 may offer free food, beverages, and/or meetings with celebrities at the golf course. The user may accept the promotional offers, e.g., order food and/or beverages and/or schedule the meeting with the celebrities via the AI assistant application 108. In some embodiments, the AI assistant application 108 and/or models 110 may determine periods of downtime at an event, e.g., when athletes are not participating, during commercial breaks, etc. The AI assistant application 108 and/or models 110 may then surface content to the user devices 104 during these downtime periods.

In some embodiments, the AI assistant application 108 may include interfaces to receive user preferences and/or customizations. Examples of such interfaces include graphical user interface 402. For example, the AI assistant application 108 may provide interfaces for dietary preferences, favorite athletes and/or celebrities, in-app preferences (e.g., what features of the AI assistant application 108 should be exposed to the user), etc., and store user-provided values in a profile 128 for the user. Doing so allows the AI assistant application 108 and/or models 110 to reference the preferences when generating responses to user input and/or presenting information to the user. Embodiments are not limited in these contexts.

In one embodiment, when a user decides to enroll in a mobile banking program, the user downloads or otherwise obtains the mobile banking system client application from a mobile banking system, for example enterprise system 100, or from a distinct application server. In other embodiments, the user interacts with a mobile banking system via a web browser application in addition to, or instead of, the mobile P2P payment system client application.

The network 106 may also incorporate various cloud-based deployment models including private cloud (e.g., an organization-based cloud managed by either the organization or third parties and hosted on-premises or off premises), public cloud (e.g., cloud-based infrastructure available to the general public that is owned by an organization that sells cloud services), community cloud (e.g., cloud-based infrastructure shared by several organizations and manages by the organizations or third parties and hosted on-premises or off premises), and/or hybrid cloud (e.g., composed of two or more clouds e.g., private community, and/or public).

The user devices 104 may include automatic teller machines (ATMs) utilized by the system 100 in serving users. In another example, the computing devices 102 represent payment clearinghouse or payment rail systems for processing payment transactions, and in another example, the computing devices 102 such as merchant systems or banking systems configured to interact with the user devices 104 during transactions and also configured to interact with the enterprise system 100 in back-end transactions clearing processes.

The user devices 104 may also be configured to obtain and process various forms of authentication via an authentication system to obtain authentication information of a user. Various authentication systems may include, according to various embodiments, a recognition system that detects biometric features or attributes of a user such as, for example fingerprint recognition systems and the like (hand print recognition systems, palm print recognition systems, etc.), iris recognition and the like used to authenticate a user based on features of the user's eyes, facial recognition systems based on facial features of the user, DNA-based authentication, or any other suitable biometric attribute or information associated with a user. Additionally or alternatively, voice biometric systems may be used to authenticate a user using speech recognition associated with a word, phrase, tone, or other voice-related features of the user. Alternate authentication systems may include one or more systems to identify a user based on a visual or temporal pattern of inputs provided by the user. For instance, the user device may display, for example, selectable options, shapes, inputs, buttons, numeric representations, etc. that must be selected in a pre-determined specified order or according to a specific pattern. Other authentication processes are also contemplated herein including, for example, email authentication, password protected authentication, device verification of saved devices, code-generated authentication, text message authentication, phone call authentication, etc. The user device may enable users to input any number or combination of authentication systems.

System 100 as illustrated diagrammatically represents at least one example of a possible implementation, where alternatives, additions, and modifications are possible for performing some or all of the described methods, operations, and functions. Although shown separately, in some embodiments, two or more systems, servers, or illustrated components may be utilized. In some implementations, the functions of one or more systems, servers, or illustrated components may be provided by a single system or server. In some embodiments, the functions of one illustrated system or server may be provided by multiple systems, servers, or computing devices, including those physically located at a central facility, those logically local, and those located as remote with respect to each other.

The system 100 can offer any number or type of services and products to one or more users. In some examples, an enterprise system 100 offers products. In some examples, an enterprise system 100 offers services. Use of “service(s)” or “product(s)” thus relates to either or both in these descriptions. With regard, for example, to online information and financial services, “service” and “product” are sometimes termed interchangeably. In non-limiting examples, services and products include retail services and products, information services and products, custom services and products, predefined or pre-offered services and products, consulting services and products, advising services and products, forecasting services and products, internet products and services, social media, and financial services and products, which may include, in non-limiting examples, services and products relating to banking, checking, savings, investments, credit cards, automatic-teller machines, debit cards, loans, mortgages, personal accounts, business accounts, account management, credit reporting, credit requests, and credit scores.

To provide access to, or information regarding, some or all the services and products of the enterprise system 100, automated assistance may be provided by the enterprise system 100. For example, automated access to user accounts and replies to inquiries may be provided by enterprise-side automated voice, text, and graphical display communications and interactions. In at least some examples, any number of human agents, can be employed, utilized, authorized, or referred by the enterprise system 100. Such human agents can be, as non-limiting examples, point of sale or point of service (POS) representatives, online customer service assistants available to users, advisors, managers, sales team members, and referral agents ready to route user requests and communications to preferred or particular other agents, human or virtual.

Human agents may utilize agent devices (e.g., user devices 104) to serve users in their interactions to communicate and take action. In such embodiments, the user devices 104 can be, as non-limiting examples, computing devices, kiosks, terminals, smart devices such as phones, and devices and tools at customer service counters and windows at POS locations.

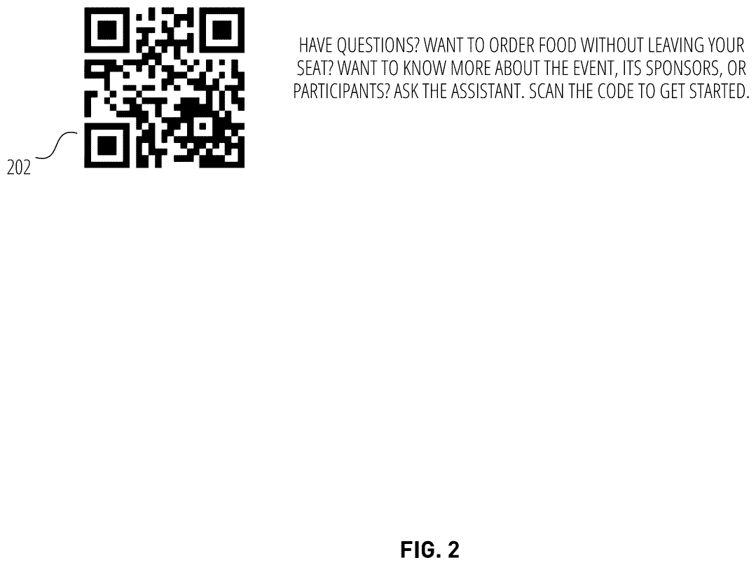

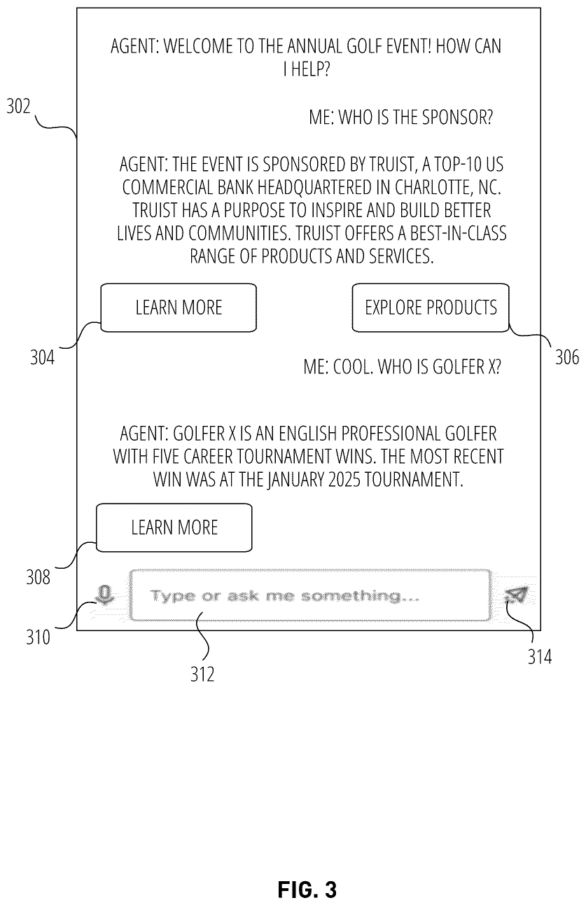

FIG. 2 illustrates an example matrix code 202. Generally, at a given location, such as the location of an event, a meeting, a conference, etc., a plurality of copies of the matrix code 202 may be displayed. The matrix code 202 may be displayed on printed media, display devices, and/or user devices 104 (e.g., in an advertisement, on a website, in an application, etc.). The matrix code 202 may encode one or more links, e.g., links to websites including the AI assistant application 108, links to an application store where the AI assistant application 108 may be downloaded, etc. In some embodiments, a plurality of the matrix codes 202 encode different links, e.g., to each of the graphical user interfaces 302-1002 depicted in FIGS. 3-10.

For example, the matrix code 202 may be displayed near the entrance of an office building. A user may use user device 104 to scan the matrix code 202 to download and install the AI assistant application 108 on the user device 104 from the link. As another example, the scanning of matrix code 202 may launch the web browser 120 to access a website at the link, where the website includes the AI assistant application 108. Because the AI assistant application 108 is accessible to all users, the AI assistant application 108 may be accessed based on scanning the matrix code 202 and without requiring the user to authenticate into an account (as the user may not have an account with the entity providing the AI assistant application 108).

FIG. 3 illustrates an example graphical user interface 302 of the AI assistant application 108, according to one embodiment. The graphical user interface 302 is an example of a user interface that may be displayed by the AI assistant application 108 based on the scanning of the matrix code 202. For example, the graphical user interface 302 may be part of a website including the AI assistant application 108 and/or part of the AI assistant application 108 (e.g., an application page) at a link that is encoded in the matrix code 202. Embodiments are not limited in these contexts.

As shown, the graphical user interface 302 includes an input element 312 to receive text-based user input, e.g., natural language questions. A selectable element 310 may engage a speech-based input mode, e.g., such that the user can provide speech input to the AI assistant application 108. When speech input is provided, the AI assistant application 108 may convert the speech to text (e.g., using one or more speech to text algorithms). The submission element 314 may submit the user's query to the AI assistant application 108. Embodiments are not limited in these contexts.

As shown, the graphical user interface 302 depicts a portion of a conversation between a user and the AI assistant application 108 at a golf event. More specifically, the user asked a question about the sponsor of the golf event. As shown, the AI assistant application 108 provides a natural language response to the question based. Furthermore, the AI assistant application 108 provides a selectable element 304 and a selectable element 306 as part of the response. The selectable element 304 may be directed to a link that includes additional information (e.g., one or more websites, one or more pages of the AI assistant application 108, etc.) about the sponsor of the event. The selectable element 306 may be directed to a link that includes information about products provided by the sponsor (e.g., one or more websites, one or more pages of the AI assistant application 108, etc.)

Furthermore, as shown, the user asks the AI assistant application 108 a question about a golfer participating in the event. Because the aggregated data 114 includes information from the golf league (e.g., golfer information, statistics, records, etc., pulled from the data 118 of the golf league), the AI assistant application 108 may generate a natural language response including information describing the golfer, e.g., the most recent win, career wins, etc. Similarly, a selectable element 308 generated by the AI assistant application 108 may be directed to another source of information describing the golfer, e.g., a profile page of the golfer, etc. Embodiments are not limited in these contexts.

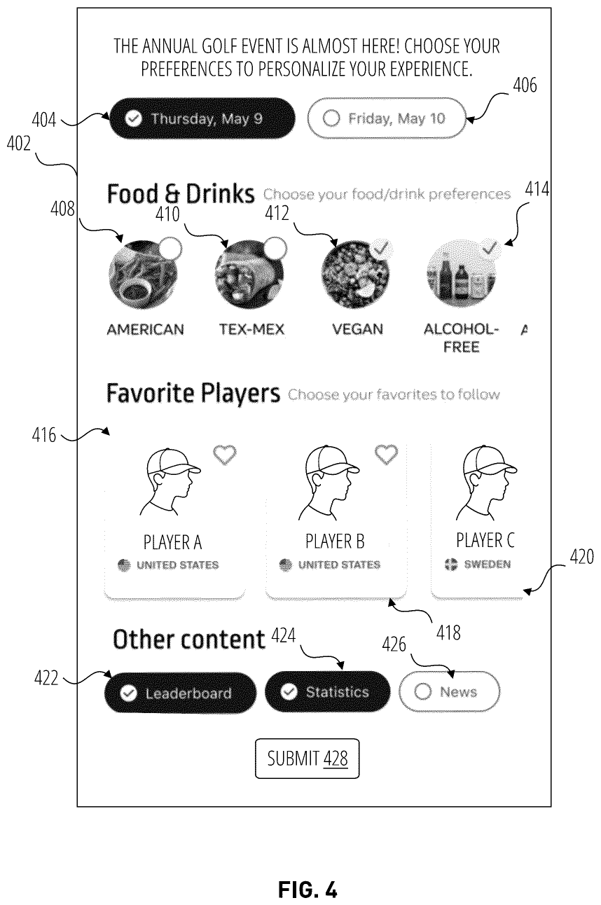

FIG. 4 illustrates an example graphical user interface 402 of the AI assistant application 108, according to one embodiment. The graphical user interface 402 is an example of a user interface that may be displayed by the AI assistant application 108 based on the scanning of the matrix code 202. For example, the graphical user interface 402 may be part of a website including the AI assistant application 108 and/or part of the AI assistant application 108 (e.g., an application page) at a link that is encoded in the matrix code 202. Embodiments are not limited in these contexts.

Generally, the graphical user interface 402 allows the user to specify one or more preferences for a golf event via a plurality of selectable elements 404-426. The preferences received via the selectable elements 404-426 may be stored in the aggregated data 114 and/or a user profile 128 for authenticated users. In some embodiments, for unauthenticated users, the preferences may be stored in a session profile in the profiles 128, which may be limited to a session between the unauthenticated user and the AI assistant application 108. For example, as shown, selectable element 404 and selectable element 406 may be used to filter preferences based on one or more associated dates. As another example, selectable elements 408-414 may be used to select dietary preferences. For example, by selecting selectable element 412, the AI assistant application 108 may limit menu items displayed to the user to vegan items. Using selectable element 416-selectable element 420, the user may specify one or more favorite players. Doing so may cause the AI assistant application 108 to provide updates, notifications, or any other type of content associated with the selected players to the user. Similarly, using selectable element 422-selectable element 426, the user may select from a plurality of types of content. When selected, the AI assistant application 108 may output content types associated with the preferences. For example, if the user selects selectable element 422, the AI assistant application 108 may periodically output the leaderboard for the golf event. The user may submit the preference selections via submission element 428. The preference selections may be stored in a profile 128, e.g., a user profile for an authenticated user or a session profile for an unauthenticated user. Embodiments are not limited in these contexts.

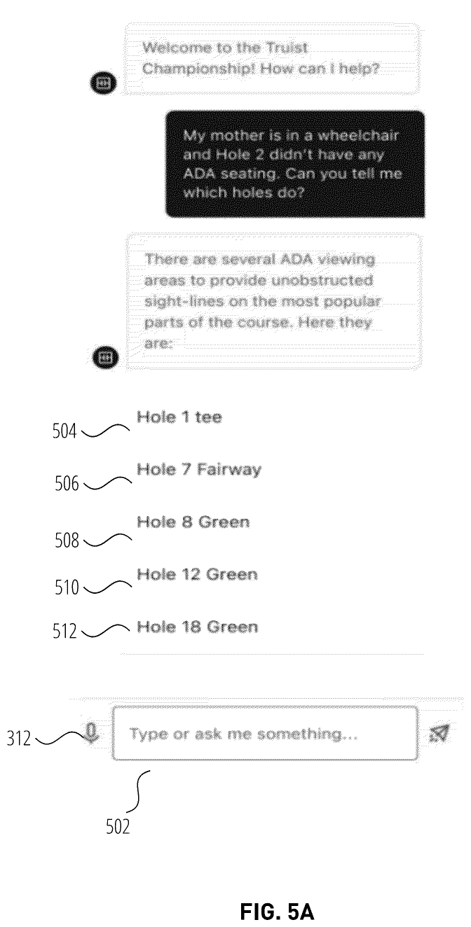

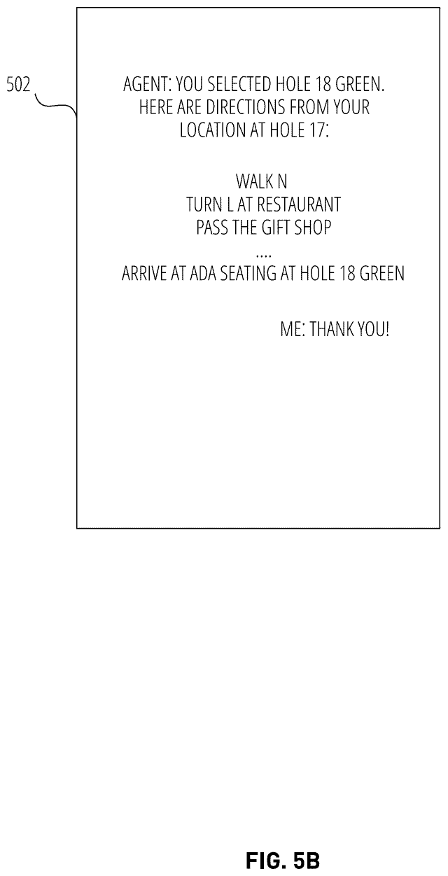

FIG. 5A illustrates an example graphical user interface 502 of the AI assistant application 108, according to one embodiment. The graphical user interface 502 is an example of a user interface that may be displayed by the AI assistant application 108 based on the scanning of the matrix code 202. For example, the graphical user interface 502 may be part of a website including the AI assistant application 108 and/or part of the AI assistant application 108 (e.g., an application page) at a link that is encoded in the matrix code 202. Embodiments are not limited in these contexts.

The graphical user interface 502 further depicts a portion of a conversation between a user and the AI assistant application 108 at a golf event. More specifically, the user asked a question about accessible seating locations at the golf event. The AI assistant application 108 processed the question to identify several holes at the golf course that have accessible seating. As shown, the AI assistant application 108 returns selectable elements 504-512, where each selectable element corresponds to a distinct physical location at the golf course. When selected, the selectable elements 504-512 may display additional information about the corresponding location, e.g., navigation instructions, distance, time to the location, available amenities, etc.

FIG. 5B illustrates the graphical user interface 502 after the user selects the selectable element 512 of FIG. 5A, according to one embodiment. As shown, the AI assistant application 108 returns navigation instructions to the selected location at the golf course. The navigation instructions may be based on the location of the user device 104. The AI assistant application 108 may determine the location of the user device 104 based on a GPS location and/or a Wi-Fi location provided by the user device 104. Embodiments are not limited in these contexts.

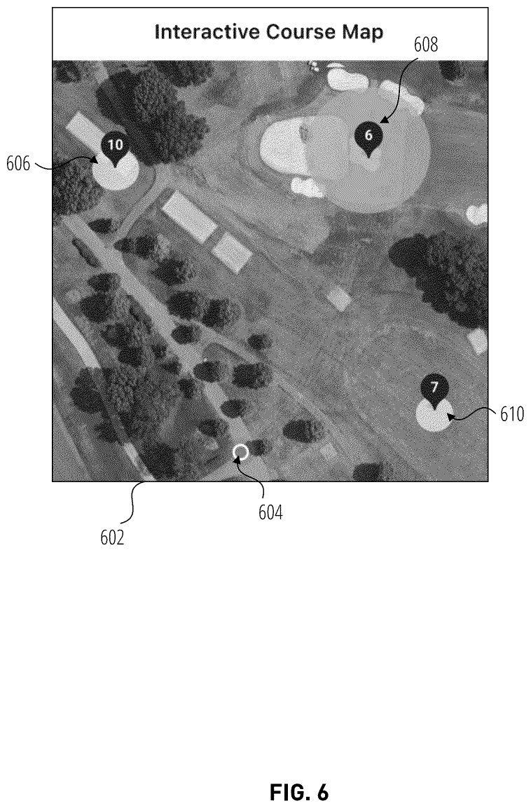

FIG. 6 illustrates an example graphical user interface 602 of the AI assistant application 108, according to one embodiment. The graphical user interface 602 is an example of a user interface that may be displayed by the AI assistant application 108 on user device 104 based on the scanning of the matrix code 202. For example, the graphical user interface 602 may be part of a website including the AI assistant application 108 and/or part of the AI assistant application 108 (e.g., an application page) at a link that is encoded in the matrix code 202. As another example, graphical user interface 602 may be presented as part of navigation requests within the AI assistant application 108. For example, the graphical user interface 602 may be displayed prior to, subsequent to, and/or contemporaneously with the graphical user interfaces 502 of FIG. 5A-FIG. 5B. Embodiments are not limited in these contexts.

The graphical user interface 602 generally displays a map of a portion of a golf course. As shown, the graphical user interface 602 includes a location indicator 604, a landmark 606, a landmark 608, and a landmark 610. The location indicator 604 may generally approximate the location of the user and/or user device 104 displaying the graphical user interface 602, e.g., based on the a GPS location and/or Wi-Fi location provided by the user device 104. The landmarks 606-608 are selectable elements which, when selected by the user, instruct the AI assistant application 108 to generate navigation instructions. For example, by selecting landmark 610, the AI assistant application 108 may generate navigation instructions from location indicator 604 to landmark 610. For example, the AI assistant application 108 may overlay graphical indicators of the instructions on graphical user interface 602. In some embodiments, examples of navigation instructions include graphical user interfaces 502 of FIG. 5A-FIG. 5B. Embodiments are not limited in these contexts.

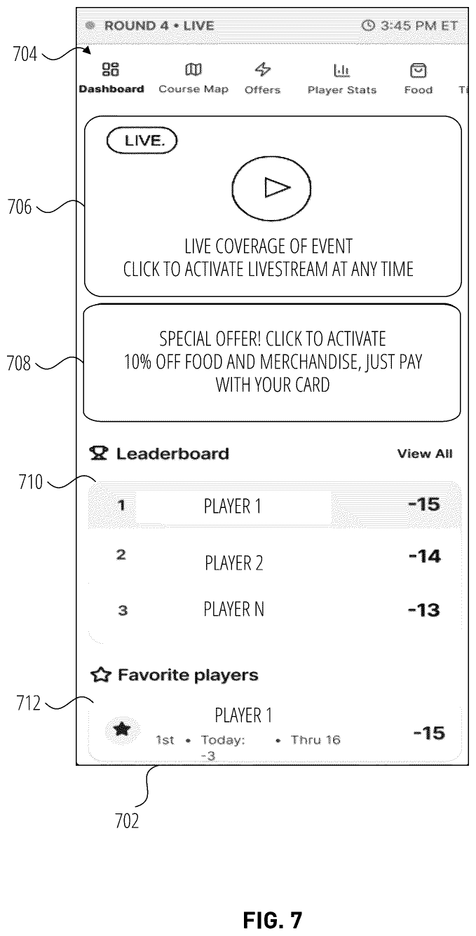

FIG. 7 illustrates a graphical user interface 702, according to one embodiment. The graphical user interface 702 is an example of a user interface that may be displayed by the AI assistant application 108 on user device 104 based on the scanning of the matrix code 202. For example, the graphical user interface 702 may be part of a website including the AI assistant application 108 and/or part of the AI assistant application 108 (e.g., an application page) at a link that is encoded in the matrix code 202. Embodiments are not limited in these contexts.

As shown, the graphical user interface 702 includes a quick access menu 704, a video 706, a promotional offer 708, a leaderboard 710, and a favorite players section 712. The quick access menu 704 includes a plurality of selectable elements enabling the user to access content such as course maps, offers, player statistics, food ordering, ticketing, and other event-specific features in the AI assistant application 108.

The video 706 is selectable to initiate a livestream of a sporting event being played at a physical location, such as a golf tournament at a golf course. However, the video 706 may be any type of video. The promotional offer 708 is an offer that may be generated by the AI assistant application 108 and/or models 110 based on the user's profile 128. The leaderboard 710 reflects the real-time rankings and scores of players participating in the sporting event. The favorite players section 712 provides performance data and other metadata of one or more players specified as favorites in the profile 128 of a user.

Therefore, as shown in graphical user interface 702, the AI assistant application 108 may display a dynamically generated dashboard summarizing event-specific content based on the user's preferences, real-time data, and/or contextual signals. The graphical user interface 702 may include live event video, real-time scoring feeds, personalized promotional offers, rankings, and content linked to user-identified favorite players. The AI assistant application 108 may update the graphical user interface 702 continuously by retrieving event data feeds of event data 126 from the event systems 122, telemetry from event systems 122, or preference data from user profiles 128. In some embodiments, the AI assistant application 108 may prioritize the display of elements in the graphical user interface 702 based on a scoring model based on user engagement, proximity to event areas, historical interest patterns, and/or time-sensitive updates. Embodiments are not limited in these contexts.

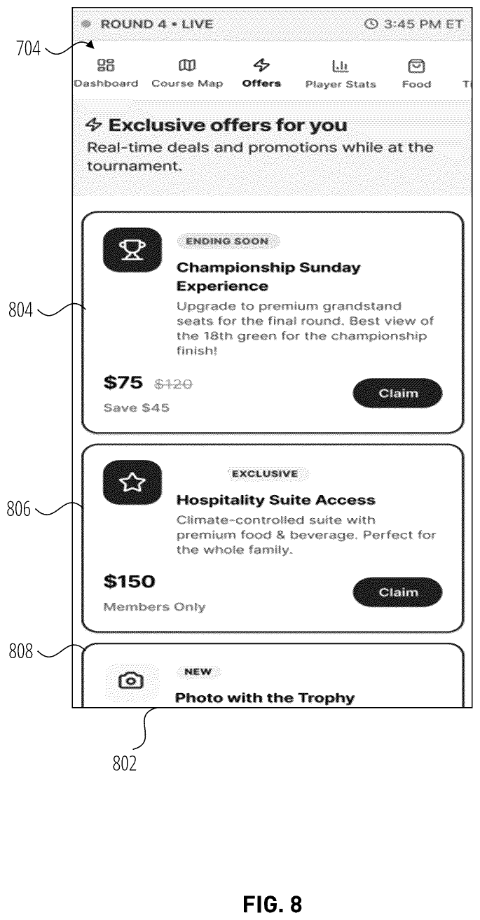

FIG. 8 illustrates a graphical user interface 802, according to one embodiment. The graphical user interface 802 is an example of a user interface that may be displayed by the AI assistant application 108 on user device 104 based on the scanning of the matrix code 202. For example, the graphical user interface 802 may be part of a website including the AI assistant application 108 and/or part of the AI assistant application 108 (e.g., an application page) at a link that is encoded in the matrix code 202. Embodiments are not limited in these contexts.

The graphical user interface 802 comprises the quick access menu 704, a selectable option 804, a selectable option 806, and a selectable option 808. The selectable options 804-808 are associated with promotional offers, such as upgraded experiences via selectable option 804, suite access via selectable option 806, and photo opportunities via selectable option 808. In some embodiments, the promotions associated with selectable options 804-808 may be generated by the AI assistant application 108 and/or models 110 based on profile characteristics in the profiles 128, such as membership tiers, event timing, and/or predicted user interests.

Therefore, as shown in graphical user interface 802, the AI assistant application 108 and/or models 110 may generate curated offers relevant to an event attendee. The AI assistant application 108 and/or models 110 may identify, rank, and present offers using a constraint-based model 110 configured to incorporate user membership level, geographic position at the event, prior purchasing behavior, or event-phase-specific factors such as break periods or session transitions. The AI assistant application 108 and/or models 110 may further classify offers based on timing, promotional tier, or exclusivity criteria. In some embodiments, the AI assistant application 108 and/or models 110 use predictive modeling to determine the likelihood of user redemption and dynamically updates the order or visibility of offers accordingly. Embodiments are not limited in these contexts.

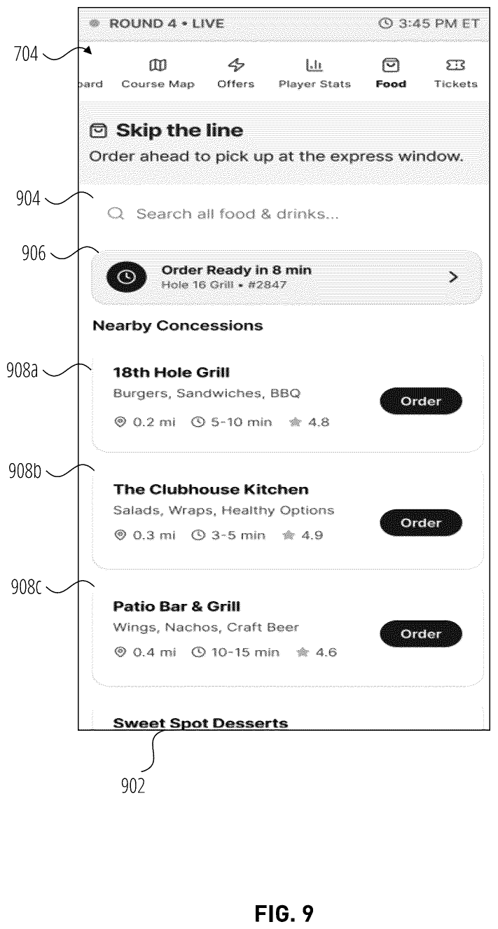

FIG. 9 illustrates a graphical user interface 902, according to one embodiment. The graphical user interface 902 is an example of a user interface that may be displayed by the AI assistant application 108 on user device 104 based on the scanning of the matrix code 202. For example, the graphical user interface 902 may be part of a website including the AI assistant application 108 and/or part of the AI assistant application 108 (e.g., an application page) at a link that is encoded in the matrix code 202. Embodiments are not limited in these contexts.

As shown, the graphical user interface 902 comprises the quick access menu 704, quick access menu 704, a search bar 904, an order status indicator 906, and a plurality of selectable options 908a-908c. The search bar 904 allows the user to search across available restaurants or retail outlets at a physical location, such as a golf course. In some embodiments, the search bar 904 may search for food and beverage items available for purchase at one or more of the restaurants. The order status indicator 906 displays details of a previously placed order, including a time the order is estimated to be ready for pickup. The order status indicator 906 may be selected to display further details of the order. In some embodiments, based on selection of order status indicator 906, the system may generate navigation instructions to the restaurant from the current location of the user device 104.

The selectable options 908a-908c are associated with restaurants, concessions, or other amenities at the location. In some embodiments, the AI assistant application 108 and/or models 110 may score each selectable option 908a-908c based on proximity to the user device 104, expected wait time, average review rating, and/or cuisine category. In some embodiments, the AI assistant application 108 and/or models 110 may integrate real-time ordering with predictive wait-time analytics. For example, the AI assistant application 108 and/or models 110 may receive queue telemetry from event systems 122, including order volume, staffing levels, and/or preparation durations. Based on this input, the AI assistant application 108 and/or models 110 may compute order readiness times and present recommendations (e.g., selectable options 908a-908c) ranked by proximity, predicted wait time, cuisine type, and/or user dietary preferences. Doing so may result in the selectable options 908a-908c, which may be a subset of available dining options at the location. For example, restaurants that are farther from the location of the user device 104 and/or restaurants with long wait times may be moved towards the bottom of the list and/or filtered such that these locations are not presented as one of the selectable options 908a-908c. Each of the selectable options 908a-908c may be selected to view menus, place orders, view wait times, load navigation instructions, etc. Embodiments are not limited in these contexts.

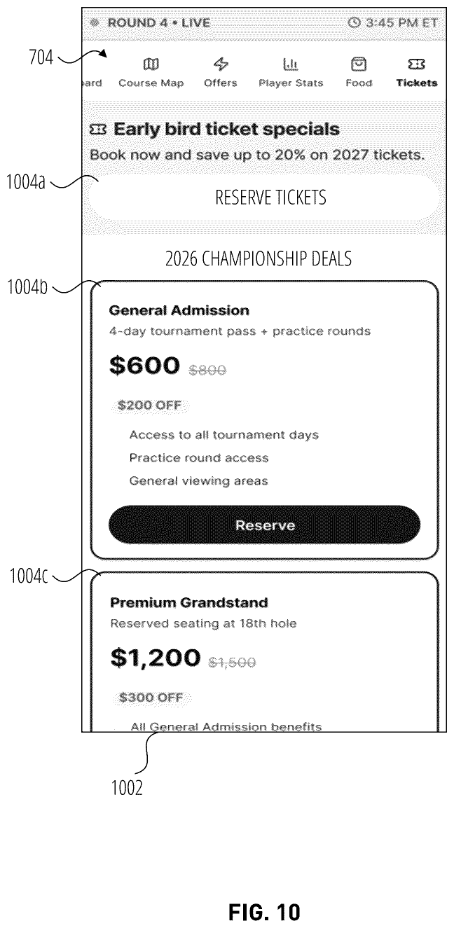

FIG. 10 illustrates a graphical user interface 1002, according to one embodiment. The graphical user interface 1002 is an example of a user interface that may be displayed on user device 104 by the AI assistant application 108 based on the scanning of the matrix code 202. For example, the graphical user interface 1002 may be part of a website including the AI assistant application 108 and/or part of the AI assistant application 108 (e.g., an application page) at a link that is encoded in the matrix code 202. Embodiments are not limited in these contexts.

As shown, the graphical user interface 1002 comprises the quick access menu 704 and a plurality of selectable options 1004a-1004c, each associated with one or more promotional offers. For example, the AI assistant application 108 and/or models 110 may include logic for dynamically generating discounted pricing and/or early-bird offers. For example, the AI assistant application 108 and/or AI models 110 may generate offers based on the profiles 128, event data 126, historical purchasing patterns, and/or predicted interest in upcoming events. In the example depicted in FIG. 10, the selectable option 1004a may be associated with a promotional offer to purchase tickets for a future event. Similarly, for the current event, e.g., a golf tournament, the selectable option 1004b may be associated with discounted admission, while selectable option 1004c may be associated with an upgraded experience. The user may select any of the selectable options 1004a-1004c to complete the corresponding transaction, e.g., via a one-tap reservation or checkout through the AI assistant application 108.

Therefore, the AI assistant application 108 and/or models 110 may manage ticketing workflows and promotional access to current or future events. The graphical user interface 1002 may display dynamically updated ticket pricing based on available inventory, time-remaining windows, and/or promotional triggers. In some embodiments, the AI assistant application 108 and/or models 110 may identify and present future-event opportunities using a predictive analysis that evaluates user interest, past attendance, the profiles 128, and/or behavioral attributes. Embodiments are not limited in these contexts.

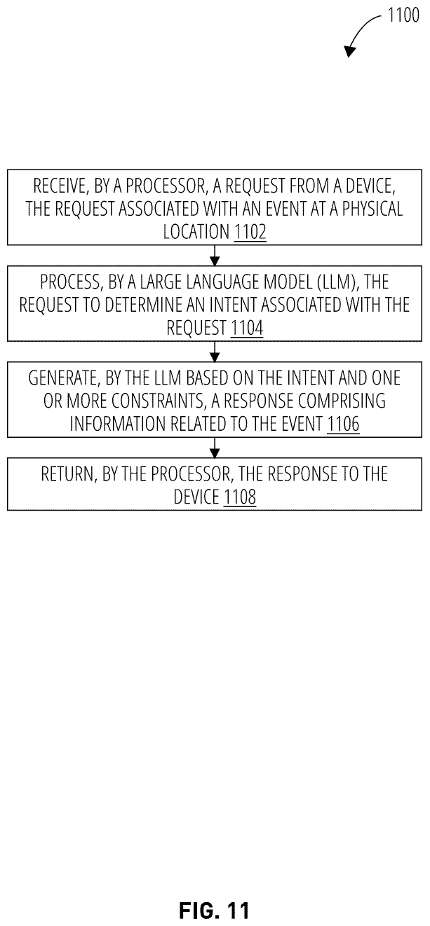

FIG. 11 illustrates an example logic flow 1100 for providing an artificial intelligence assistant for constraint-based response generation, according to one embodiment. Although the example logic flow 1100 depicts a particular sequence of operations, the sequence may be altered without departing from the scope of the present disclosure. For example, some of the operations depicted may be performed in parallel or in a different sequence that does not materially affect the function of the logic flow 1100. In other examples, different components of an example device or system that implements the logic flow 1100 may perform functions at substantially the same time or in a specific sequence.

According to some examples, the logic flow 1100 includes receiving, by a processor, a request from a client device, the request associated with an event at a physical location at block 1102. For example, the AI assistant application 108 illustrated in FIG. 1 may receive a request from a client device, the request associated with an event at a physical location. For example, a user of the AI assistant application 108 on a user device 104 and/or the computing device 102 may provide a natural language query to the AI assistant application 108, such as “where can I find an employee break room during a meeting at the Truist Innovation and Technology Center?”

According to some examples, the logic flow 1100 includes processing, by a large language model, the request to determine an intent associated with the request at block 1104. For example, the model 110 illustrated in FIG. 1 may process the request to determine an intent associated with the request and determine the user is looking for directions to a break room while attending a meeting at the Truist Innovation and Technology Center.

According to some examples, the logic flow 1100 includes generating, by the LLM based on the intent and one or more constraints, a response comprising information related to the event at block 1106. For example, the model 110 illustrated in FIG. 1 may generate, based on the intent and one or more constraints in the model configuration 112, a response comprising information related to the event. For example, the model 110 may determine the location the user's device, e.g., based on a GPS module of the user device 104, Wi-Fi based location determination, etc. Similarly, the model 110 may determine a list of break rooms at the Center. In some embodiments, the model 110 may score each break room as being most relevant to the user's request, and select the highest scoring break room to include in a natural language response to the user. For example, the scores may be based on the distance from the user's location to each break room. The response may indicate the identified break room and include directions to allow the user to find their way to the break room.

According to some examples, the logic flow 1100 includes returning, by the processor, the response to the client device at block 1108. For example, the AI assistant application 108 illustrated in FIG. 1 may return the response to the client device. As stated, the AI assistant application 108 may return a response indicating the identified breakroom and the directions thereto. Embodiments are not limited in these contexts.

As used herein, an artificial intelligence system, artificial intelligence agent, artificial intelligence algorithm, artificial intelligence module, program, and the like, generally refer to computer implemented programs that are suitable to simulate intelligent behavior (e.g., intelligent human behavior) and/or computer systems and associated programs suitable to perform tasks that typically require a human to perform, such as tasks requiring visual perception, speech recognition, decision-making, translation, and the like. An artificial intelligence system may include, for example, at least one of a series of associated if-then logic statements, a statistical model suitable to map raw sensory data into symbolic categories and the like, or a machine learning program. A machine learning program, machine learning algorithm, or machine learning module, as used herein, is generally a type of artificial intelligence including one or more algorithms that can learn and/or adjust parameters based on input data provided to the algorithm. In some instances, machine learning programs, algorithms, and modules are used at least in part in implementing artificial intelligence (AI) functions, systems, and methods.

Artificial Intelligence and/or machine learning programs may be associated with or conducted by one or more processors, memory devices, and/or storage devices of a computing system or device. It should be appreciated that the AI algorithm or program may be incorporated within the existing system architecture or be configured as a standalone modular component, controller, or the like communicatively coupled to the system. An AI program and/or machine learning program may generally be configured to perform methods and functions as described or implied herein, for example by one or more corresponding flow charts expressly provided or implied as would be understood by one of ordinary skill in the art to which the subjects matters of these descriptions pertain.

A machine learning program may be configured to use various analytical tools (e.g., algorithmic applications) to leverage data to make predictions or decisions. Machine learning programs may be configured to implement various algorithmic processes and learning approaches including, for example, decision tree learning, association rule learning, artificial neural networks, recurrent artificial neural networks, long short term memory networks, inductive logic programming, support vector machines, clustering, Bayesian networks, reinforcement learning, representation learning, similarity and metric learning, sparse dictionary learning, genetic algorithms, k-nearest neighbor (KNN), and the like. In some embodiments, the machine learning algorithm may include one or more image recognition algorithms suitable to determine one or more categories to which an input, such as data communicated from a visual sensor or a file in JPEG, PNG, or other format, representing an image or portion thereof, belongs. Additionally or alternatively, the machine learning algorithm may include one or more regression algorithms configured to output a numerical value given an input. Further, the machine learning may include one or more pattern recognition algorithms, e.g., a module, subroutine or the like capable of translating text or string characters and/or a speech recognition module or subroutine. In various embodiments, the machine learning module may include a machine learning acceleration logic, e.g., a fixed function matrix multiplication logic, to implement the stored processes and/or optimize the machine learning logic training and interface.

Machine learning models are trained using various data inputs and techniques. Example training methods may include, for example, supervised learning, (e.g., decision tree learning, support vector machines, similarity and metric learning, etc.), unsupervised learning, (e.g., association rule learning, clustering, etc.), reinforcement learning, semi-supervised learning, self-supervised learning, multi-instance learning, inductive learning, deductive inference, transductive learning, sparse dictionary learning and the like. Example clustering algorithms used in unsupervised learning may include, for example, k-means clustering, density based special clustering of applications with noise (DBSCAN), mean shift clustering, expectation maximization (EM) clustering using Gaussian mixture models (GMM), agglomerative hierarchical clustering, or the like. According to one embodiment, clustering of data may be performed using a cluster model to group data points based on certain similarities using unlabeled data. Example cluster models may include, for example, connectivity models, centroid models, distribution models, density models, group models, graph based models, neural models and the like.

One subfield of machine learning includes neural networks, which take inspiration from biological neural networks. In machine learning, a neural network includes interconnected units that process information by responding to external inputs to find connections and derive meaning from undefined data. A neural network can, in a sense, learn to perform tasks by interpreting numerical patterns that take the shape of vectors and by categorizing data based on similarities, without being programmed with any task-specific rules. A neural network generally includes connected units, neurons, or nodes (e.g., connected by synapses) and may allow for the machine learning program to improve performance. A neural network may define a network of functions, which have a graphical relationship. Various neural networks that implement machine learning exist including, for example, feedforward artificial neural networks, perceptron and multilayer perceptron neural networks, radial basis function artificial neural networks, recurrent artificial neural networks, modular neural networks, long short term memory networks, as well as various other neural networks.

Neural networks may perform a supervised learning process where known inputs and known outputs are utilized to categorize, classify, or predict a quality of a future input. However, additional or alternative embodiments of the machine learning program may be trained utilizing unsupervised or semi-supervised training, where none of the outputs or some of the outputs are unknown, respectively. Typically, a machine learning algorithm is trained (e.g., utilizing a training data set) prior to modeling the problem with which the algorithm is associated. Supervised training of the neural network may include choosing a network topology suitable for the problem being modeled by the network and providing a set of training data representative of the problem. Generally, the machine learning algorithm may adjust the weight coefficients until any error in the output data generated by the algorithm is less than a predetermined, acceptable level. For instance, the training process may include comparing the generated output produced by the network in response to the training data with a desired or correct output. An associated error amount may then be determined for the generated output data, such as for each output data point generated in the output layer. The associated error amount may be communicated back through the system as an error signal, where the weight coefficients assigned in the hidden layer are adjusted based on the error signal. For instance, the associated error amount (e.g., a value between −1 and 1) may be used to modify the previous coefficient, e.g., a propagated value. The machine learning algorithm may be considered sufficiently trained when the associated error amount for the output data is less than the predetermined, acceptable level (e.g., each data point within the output layer includes an error amount less than the predetermined, acceptable level). Thus, the parameters determined from the training process can be utilized with new input data to categorize, classify, and/or predict other values based on the new input data.

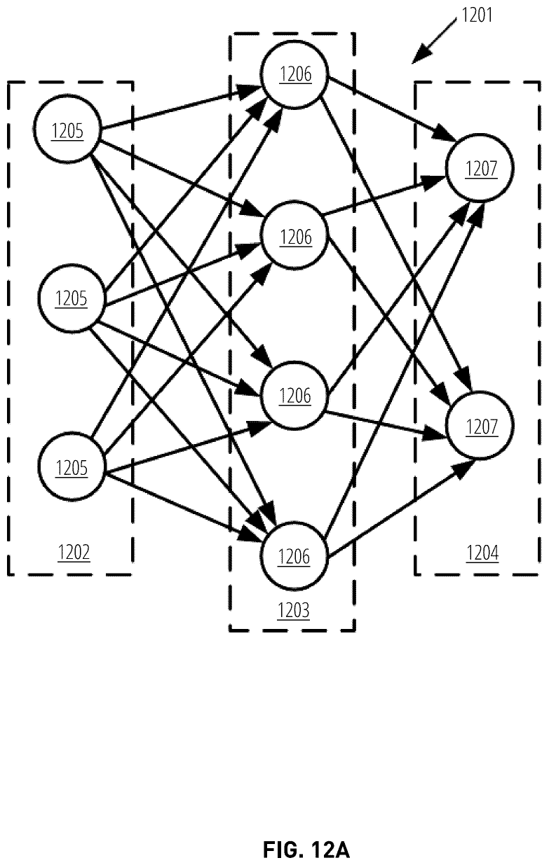

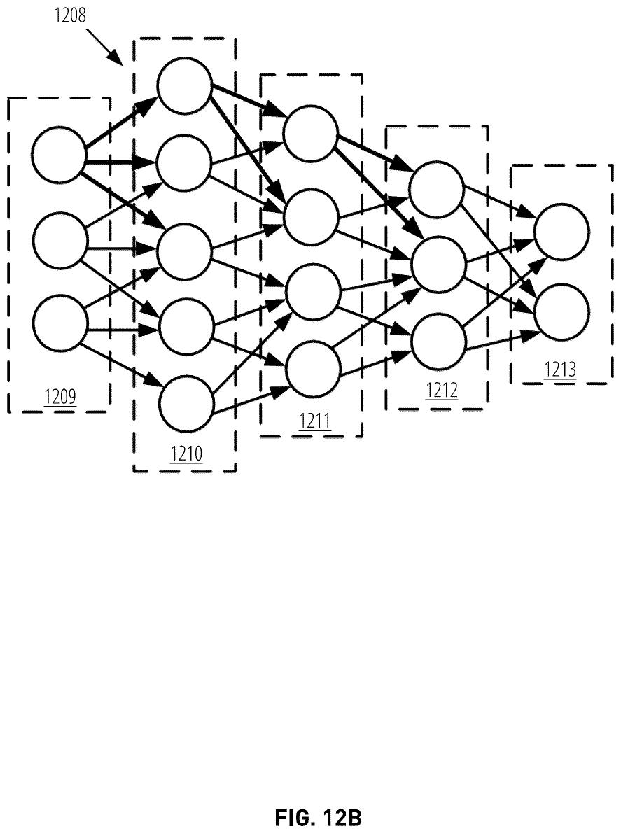

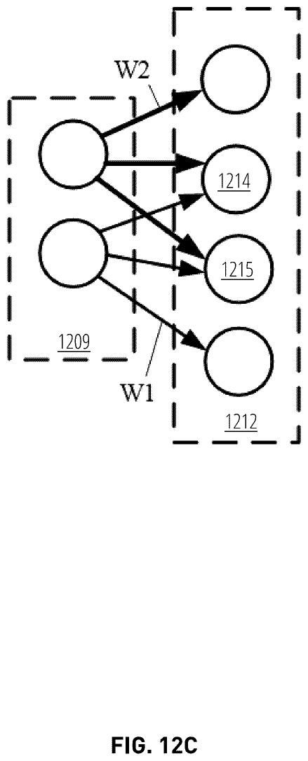

An artificial neural network (ANN), also known as a feedforward network, may be utilized, e.g., an acyclic graph with nodes arranged in layers. A feedforward network (see, e.g., feedforward network 1201 referenced in FIG. 12A) may include a topography with a hidden layer 1203 between an input layer 1202 and an output layer 1204. The input layer 1202, having nodes commonly referenced in FIG. 12A as input nodes 1205 for convenience, communicates input data, variables, matrices, or the like to the hidden layer 1203, having nodes 1206. The hidden layer 1203 generates a representation and/or transformation of the input data into a form that is suitable for generating output data. Adjacent layers of the topography are connected at the edges of the nodes of the respective layers, but nodes within a layer typically are not separated by an edge. In at least one embodiment of such a feedforward network, data is communicated to the nodes 1205 of the input layer, which then communicates the data to the hidden layer 1203. The hidden layer 1203 may be configured to determine the state of the nodes in the respective layers and assign weight coefficients or parameters of the nodes based on the edges separating each of the layers, e.g., an activation function implemented between the input data communicated from the input layer 1202 and the output data communicated to the nodes 1207 of the output layer 1204. It should be appreciated that the form of the output from the neural network may generally depend on the type of model represented by the algorithm. Although the feedforward network 1201 of FIG. 12A expressly includes a single hidden layer 1203, other embodiments of feedforward networks within the scope of the descriptions can include any number of hidden layers. The hidden layers are intermediate the input and output layers and are generally where all or most of the computation is done.

An additional or alternative type of neural network suitable for use in the machine learning program and/or module is a Convolutional Neural Network (CNN). A CNN is a type of feedforward neural network that may be utilized to model data associated with input data having a grid-like topology. In some embodiments, at least one layer of a CNN may include a sparsely connected layer, in which each output of a first hidden layer does not interact with each input of the next hidden layer. For example, the output of the convolution in the first hidden layer may be an input of the next hidden layer, rather than a respective state of each node of the first layer. CNNs are typically trained for pattern recognition, such as speech processing, language processing, and visual processing. As such, CNNs may be particularly useful for implementing optical and pattern recognition programs required from the machine learning program. A CNN includes an input layer, a hidden layer, and an output layer, typical of feedforward networks, but the nodes of a CNN input layer are generally organized into a set of categories via feature detectors and based on the receptive fields of the sensor, retina, input layer, etc. Each filter may then output data from its respective nodes to corresponding nodes of a subsequent layer of the network. A CNN may be configured to apply the convolution mathematical operation to the respective nodes of each filter and communicate the same to the corresponding node of the next subsequent layer. As an example, the input to the convolution layer may be a multidimensional array of data. The convolution layer, or hidden layer, may be a multidimensional array of parameters determined while training the model. The models 110 and/or AI assistant application 108 may each include one or more of the neural networks, such as feedforward network 1201, ANN, convolutional neural network 1208, etc.

An exemplary convolutional neural network CNN is depicted and referenced as 1208 in FIG. 12B. As in the feedforward network 1201 of FIG. 12A, the illustrated example of FIG. 12B has an input layer 1209 and an output layer 1213. However where a single hidden layer 1203 is represented in FIG. 12A, multiple consecutive hidden layers 1210, 1211, and 1212 are represented in FIG. 12B. The edge neurons represented by white-filled arrows highlight that hidden layer nodes can be connected locally, such that not all nodes of succeeding layers are connected by neurons.

FIG. 12C, representing a portion of the convolutional neural network 1208 of FIG. 12B, specifically portions of the input layer 1209 and the first hidden layer 1210, illustrates that connections can be weighted. In the illustrated example, labels W1 and W2 refer to respective assigned weights for the referenced connections. Two hidden nodes 1214 and 1215 share the same set of weights W1 and W2 when connecting to two local patches.

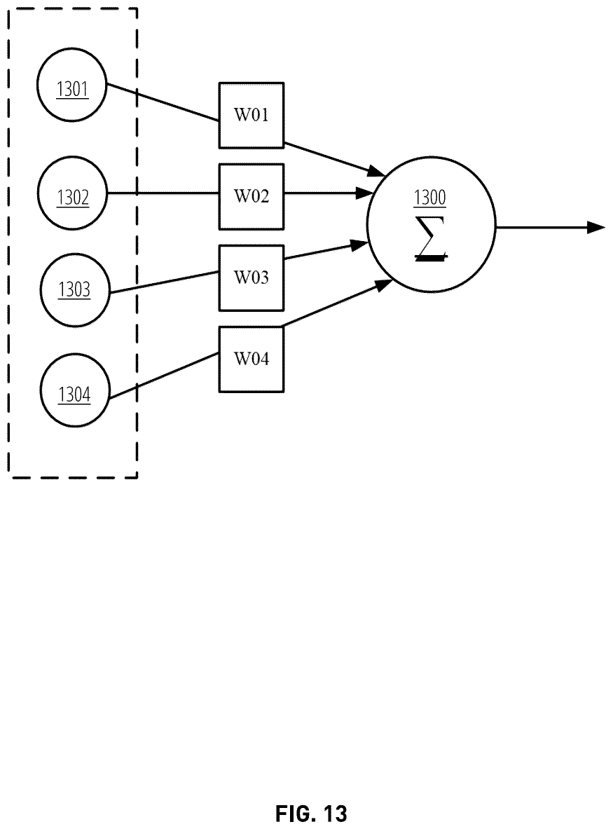

Weight defines the impact a node in any given layer has on computations by a connected node in the next layer. FIG. 13 represents a particular node 1300 in a hidden layer. The node 1300 is connected to several nodes in the previous layer representing inputs to the node 1300. The input nodes 1301, 1302, 1303 and 1304 are each assigned a respective weight W01, W02, W03, and W04 in the computation at the node 1300, which in this example is a weighted sum.

An additional or alternative type of feedforward neural network suitable for use in the machine learning program and/or module is a Recurrent Neural Network (RNN). An RNN may allow for analysis of sequences of inputs rather than only considering the current input data set. RNNs typically include feedback loops/connections between layers of the topography, thus allowing parameter data to be communicated between different parts of the neural network. RNNs typically have an architecture including cycles, where past values of a parameter influence the current computation of the parameter, e.g., at least a portion of the output data from the RNN may be used as feedback/input in computing subsequent output data. In some embodiments, the machine learning module may include an RNN configured for language processing, e.g., an RNN configured to perform statistical language modeling to predict the next word in a string based on the previous words. The RNN(s) of the machine learning program may include a feedback system suitable to provide the connection(s) between subsequent and previous layers of the network.

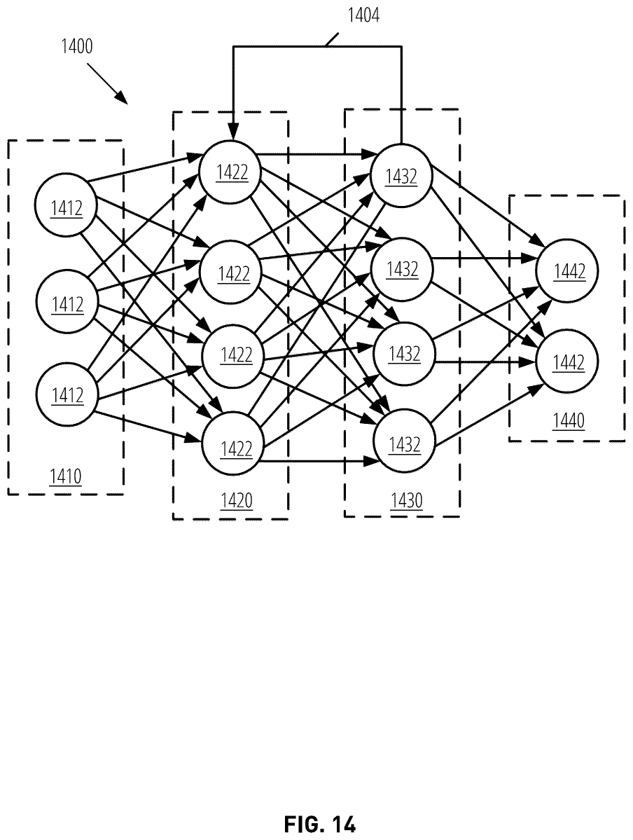

An example for a Recurrent Neural Network (RNN) is referenced as 1400 in FIG. 14. As in the feedforward network 1201 of FIG. 12A, the illustrated example of FIG. 14 has an input layer 1410 (with nodes 1412) and an output layer 1440 (with nodes 1442). However, where a single hidden layer 1203 is represented in FIG. 12A, multiple consecutive hidden layers 1420 and 1430 are represented in FIG. 14 (with nodes 1422 and nodes 1432, respectively). As shown, the RNN 1400 includes a feedback connector 1404 configured to communicate parameter data from at least one node 1432 from the second hidden layer 1430 to at least one node 1422 of the first hidden layer 1420. It should be appreciated that two or more and up to all of the nodes of a subsequent layer may provide or communicate a parameter or other data to a previous layer of the RNN 1400. Moreover and in some embodiments, the RNN 1400 may include multiple feedback connectors 1404 (e.g., connectors 1404 suitable to communicatively couple pairs of nodes and/or feedback connectors 1404 configured to provide communication between three or more nodes). Additionally or alternatively, the feedback connector 1404 may communicatively couple two or more nodes having at least one hidden layer between them, e.g., nodes of nonsequential layers of the RNN 1400. The models 110 and/or AI assistant application 108 may each include one or more RNNs 1400.

In an additional or alternative embodiment, the machine-learning program may include one or more support vector machines. A support vector machine may be configured to determine a category to which input data belongs. For example, the machine-learning program may be configured to define a margin using a combination of two or more of the input variables and/or data points as support vectors to maximize the determined margin. Such a margin may generally correspond to a distance between the closest vectors that are classified differently. The machine-learning program may be configured to utilize a plurality of support vector machines to perform a single classification. For example, the machine-learning program may determine the category to which input data belongs using a first support vector determined from first and second data points/variables, and the machine-learning program may independently categorize the input data using a second support vector determined from third and fourth data points/variables. The support vector machine(s) may be trained similarly to the training of neural networks, e.g., by providing a known input vector (including values for the input variables) and a known output classification. The support vector machine is trained by selecting the support vectors and/or a portion of the input vectors that maximize the determined margin.

As depicted, and in some embodiments, the machine-learning program may include a neural network topography having more than one hidden layer. In such embodiments, one or more of the hidden layers may have a different number of nodes and/or the connections defined between layers. In some embodiments, each hidden layer may be configured to perform a different function. As an example, a first layer of the neural network may be configured to reduce a dimensionality of the input data, and a second layer of the neural network may be configured to perform statistical programs on the data communicated from the first layer. In various embodiments, each node of the previous layer of the network may be connected to an associated node of the subsequent layer (dense layers). Generally, the neural network(s) of the machine-learning program may include a relatively large number of layers, e.g., three or more layers, and may be referred to as deep neural networks. For example, the node of each hidden layer of a neural network may be associated with an activation function utilized by the machine-learning program to generate an output received by a corresponding node in the subsequent layer. The last hidden layer of the neural network communicates a data set (e.g., the result of data processed within the respective layer) to the output layer. Deep neural networks may require more computational time and power to train, but the additional hidden layers provide multistep pattern recognition capability and/or reduced output error relative to simple or shallow machine learning architectures (e.g., including only one or two hidden layers).

According to various implementations, deep neural networks incorporate neurons, synapses, weights, biases, and functions and can be trained to model complex non-linear relationships. Various deep learning frameworks may include, for example, TensorFlow, MxNet, PyTorch, Keras, Gluon, and the like. Training a deep neural network may include complex input/output transformations and may include, according to various embodiments, a backpropagation algorithm. According to various embodiments, deep neural networks may be configured to classify images of handwritten digits from a dataset or various other images. According to various embodiments, the datasets may include a collection of files that are unstructured and lack predefined data model schema or organization. Unlike structured data, which is usually stored in a relational database (RDBMS) and can be mapped into designated fields, unstructured data comes in many formats that can be challenging to process and analyze. Examples of unstructured data may include, according to non-limiting examples, dates, numbers, facts, emails, text files, scientific data, satellite imagery, media files, social media data, text messages, mobile communication data, and the like.

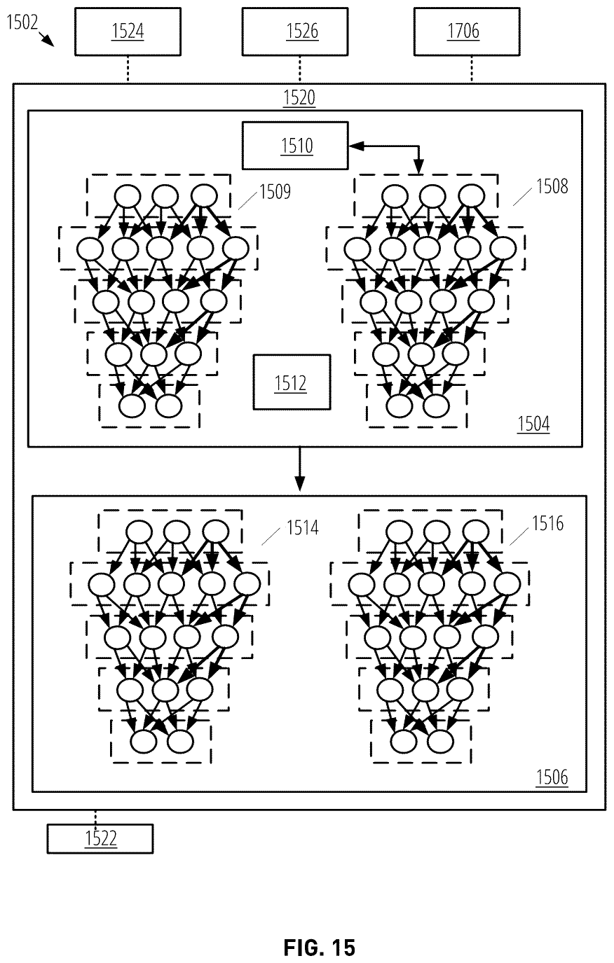

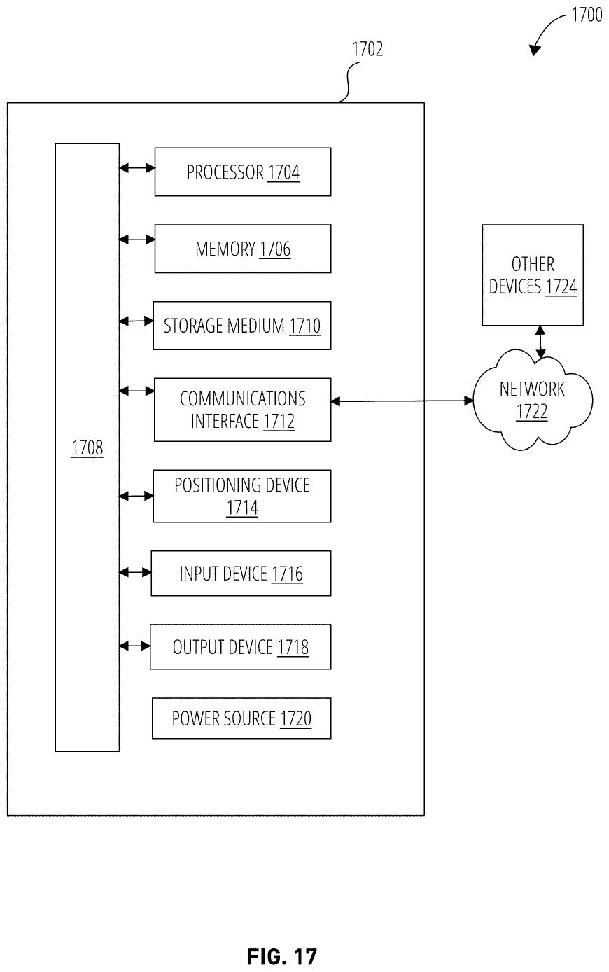

Referring now to FIG. 15 and some embodiments, an artificial intelligence (AI) program 1502 may include a front-end algorithm 1504 and a back-end algorithm 1506. The models 110 and/or AI assistant application 108 may each include one or more artificial intelligence programs 1502. The artificial intelligence program 1502 may be implemented on an AI processor 1520, such as the processor 1704 of computer 1702 of FIG. 17, and/or a dedicated processing device (e.g., computing devices 102 and/or user devices 104). The instructions associated with the front-end algorithm 1504 and the back-end algorithm 1506 may be stored in an associated memory device and/or storage device of the system (e.g., memory 1524 and/or storage 1526 in FIG. 15, etc.) communicatively coupled to the AI processor 1520, as shown. Additionally or alternatively, one or more memory devices and/or storage devices (e.g., storage medium 1710 and/or memory 1706 of FIG. 17, etc.) may be used for processing use and/or including one or more instructions necessary for operation of the AI program 1502. In some embodiments, the AI program 1502 may include a deep neural network (e.g., a front-end algorithm 1504 configured to perform pre-processing, such as feature recognition, and a back-end algorithm 1506 configured to perform an operation on the data set communicated directly or indirectly to the back-end algorithm 1506). For instance, the front-end algorithm 1504 can include at least one CNN 1508 communicatively coupled to send output data to the back-end algorithm 1506.

Additionally or alternatively, the front-end algorithm 1504 can include one or more AI algorithms 1510, 1512 (e.g., statistical models or machine learning programs such as decision tree learning, associate rule learning, recurrent artificial neural networks, support vector machines, and the like). In various embodiments, the front-end algorithm 1504 may be configured to include built in training and inference logic or suitable software to train the neural network prior to use (e.g., machine learning logic including, but not limited to, image recognition, mapping and localization, autonomous navigation, speech synthesis, document imaging, or language translation such as natural language processing). For example, a CNN 1508 and/or AI algorithm 1510 may be used for image recognition, input categorization, and/or support vector training. In some embodiments and within the front-end algorithm 1504, an output from an AI algorithm 1510 may be communicated to a CNN 1508 or 1509, which processes the data before communicating an output from the CNN 1508, 1509 and/or the front-end algorithm 1504 to the back-end algorithm 1506. In various embodiments, the back-end algorithm 1506 may be configured to implement input and/or model classification, speech recognition, translation, and the like. For instance, the back-end algorithm 1506 may include one or more CNNs (e.g., CNN 1514) or dense networks (e.g., dense networks 1516), as described herein.

For instance, and in some embodiments of the AI program 1502, the program may be configured to perform unsupervised learning, in which the machine learning program performs the training process using unlabeled data, e.g., without known output data with which to compare. During such unsupervised learning, the neural network may be configured to generate groupings of the input data and/or determine how individual input data points are related to the complete input data set (e.g., via the front-end algorithm 1504). For example, unsupervised training may be used to configure a neural network to generate a self-organizing map, reduce the dimensionality of the input data set, and/or to perform outlier/anomaly determinations to identify data points in the data set that falls outside the normal pattern of the data. In some embodiments, the AI program 1502 may be trained using a semi-supervised learning process in which some but not all of the output data is known, e.g., a mix of labeled and unlabeled data having the same distribution.

In some embodiments, the AI program 1502 may be accelerated via a machine learning framework 1522 (e.g., hardware). The machine learning framework may include an index of operations, subroutines, and the like (primitives) typically implemented by AI and/or machine learning algorithms. Thus, the AI program 1502 may be configured to utilize the primitives of the framework 1522 to perform some or all of the computations required by the AI program 1502. Primitives suitable for inclusion in the machine learning framework 1522 include operations associated with training a convolutional neural network (e.g., pools), tensor convolutions, activation functions, algebraic subroutines and programs (e.g., matrix operations, vector operations), numerical method subroutines and programs, and the like.

It should be appreciated that the machine-learning program may include variations, adaptations, and alternatives suitable to perform the operations necessary for the system, and the present disclosure is equally applicable to such suitably configured machine learning and/or artificial intelligence programs, modules, etc. For instance, the machine-learning program may include one or more long short-term memory (LSTM) RNNs, convolutional deep belief networks, deep belief networks DBNs, and the like. DBNs, for instance, may be utilized to pre-train the weighted characteristics and/or parameters using an unsupervised learning process. Further, the machine-learning module may include one or more other machine learning tools (e.g., Logistic Regression (LR), Naive-Bayes, Random Forest (RF), matrix factorization, and support vector machines) in addition to, or as an alternative to, one or more neural networks, as described herein.

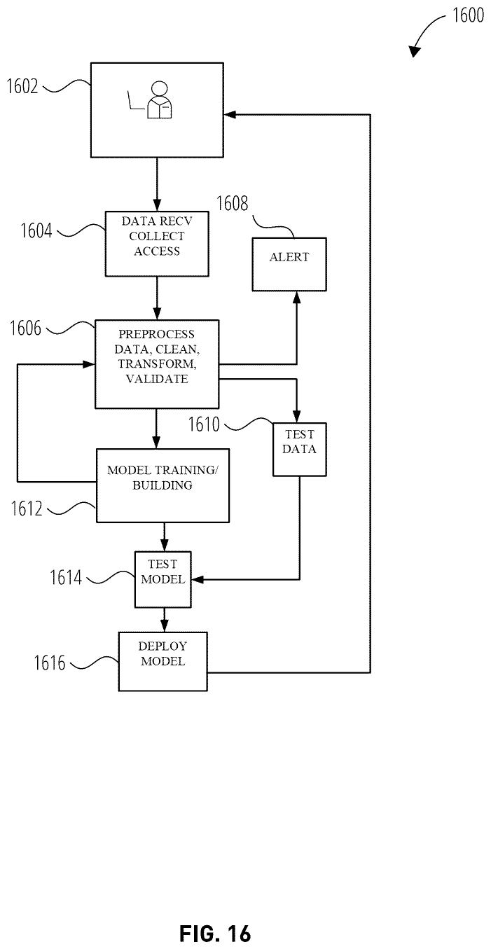

FIG. 16 is a flow chart representing a logic flow 1600, according to at least one embodiment, of model development and deployment by machine learning. The logic flow 1600 represents at least one example of a machine learning workflow in which operations are implemented in a machine-learning project.

In block 1602, a user authorizes, requests, manages, or initiates the machine-learning workflow. This may represent a user such as human agent, or customer, requesting machine-learning assistance or AI functionality to simulate intelligent behavior (such as a virtual agent) or other machine-assisted or computerized tasks that may, for example, entail visual perception, speech recognition, decision-making, translation, forecasting, predictive modelling, and/or suggestions as non-limiting examples. In a first iteration from the user perspective, block 1602 can represent a starting point. However, with regard to continuing or improving an ongoing machine learning workflow, block 1602 can represent an opportunity for further user input or oversight via a feedback loop. Such feedback may flow through a user, or in various embodiments, the method automatically provides feedback, retrains and redeploys the retrained model.

In block 1604, data is received, collected, accessed, or otherwise acquired and entered as can be termed data ingestion. In block 1606, the data ingested in block 1604 is pre-processed, for example, by cleaning, and/or transformation such as into a format that the following components can digest. The incoming data may be versioned to connect a data snapshot with the particularly resulting trained model. As newly trained models are tied to a set of versioned data, preprocessing steps are tied to the developed model. If new data is subsequently collected and entered, a new model will be generated. If the preprocessing block 1606 is updated with newly ingested data, an updated model will be generated. Block 1606 can include data validation, which focuses on confirming that the statistics of the ingested data are as expected, such as that data values are within expected numerical ranges, that data sets are within any expected or required categories, and that data comply with any needed distributions such as within those categories. Block 1606 can proceed to block 1608 to automatically alert the initiating user, other human or virtual agents, and/or other systems, if any anomalies are detected in the data, thereby pausing or terminating the process flow until corrective action is taken.

In block 1610, training test data such as a target variable value is inserted into an iterative training and testing loop. In block 1612, model training, a core step of the machine learning workflow, is implemented. A model architecture is trained in the iterative training and testing loop. For example, features in the training test data are used to train the model based on weights and iterative computations in which the target variable may be incorrectly predicted in an early iteration as determined by comparison in block 1614, where the model is tested. Subsequent iterations of the model training, in block 1612, may be conducted with updated weights in the computations.

During each iteration of the training and testing loop, the accuracy of the model may be evaluated. In one embodiment, the re-evaluation of the model can include comparing an output of the model with an actual target result or variable to determine the accuracy of the prediction. If the model is not satisfying a minimum threshold level of accuracy (e.g., the model is underfitted), the system may automatically determine that the threshold level of accuracy is not satisfied and may adjust the weights for a subsequent iteration of the training and testing loop. The weights may be iteratively adjusted during each iteration of the training and testing loop based on the comparison to the threshold level of accuracy. However, there is a balance for training the model to avoid overfitting when the model would not perform well on predictions of new data. Rather, the model is automatically trained to be well-fitted such that it satisfies a threshold level of accuracy without learning the noise in the data to the extent that the model would not apply to new data by preventing additional iterations of the training and testing once a maximum accuracy threshold value has been obtained. Thus, with each iteration of the training and testing loop, the accuracy of the model is improved and the iterative training and testing of the model provides an improvement to the performance of a computer and computing technology because the system may automatically determine how many iterations to perform so that the model is well-fitted by surpassing the minimum threshold level of accuracy while automatically stopping the iterative training and testing of the model before the maximum accuracy threshold is obtained. In some embodiments, the training and testing loop utilizes a backpropagation algorithm and a gradient descent algorithm. Gradient descent is an optimization algorithm used to minimize differentiable real-valued multivariate functions. Gradient descent is an optimization algorithm used to minimize differentiable real-valued multivariate functions. The gradient descent algorithm may be used to iteratively adjust model parameters using computed derivatives to minimize a loss function. Backpropagation may be used to compute the gradient of the error function with respect to the neural network's weights.

When compliance and/or success in the model testing in block 1614 is achieved, process flow proceeds to block 1616, where model deployment is triggered. The model may be utilized in AI functions and programming, for example to simulate intelligent behavior, to perform machine-assisted or computerized tasks, of which visual perception, speech recognition, decision-making, translation, forecasting, predictive modelling, and/or automated suggestion generation serve as non-limiting examples.

As discussed above, oversight of a deployed machine learning model may be automatically performed via a feedback loop whereby the method assesses performance of the deployed model (see block 1616) and the feedback loop automatically provides feedback for further training of the machine learning model to improve its performance, and upon completion of the other method blocks such as block 1612, the machine learning model that has been automatically retrained based on the feedback loop is then redeployed (block 1614). In some embodiments, the system is continually receiving training data as new predictions are made and more data is collected. The continuous training data may be discretized to generate input data to retrain the model. Discretization methods can convert continuous data to discrete data by binning, clustering, and numerical discretization. The model may monitor incoming data sets to make predictions. When predictions are made the system analyzes the predictions to determine whether the model needs to be retrained.

In some embodiments, the model may detect anomalies in the predictions. Anomaly detection can provide a benefit by identifying instances of the prediction that deviate from expected data or a general pattern. A difficulty in anomaly detection is that the system must define the boundary between ordinary data and anomalous data to accurately classify the data as ordinary or anomalous. The line between ordinary and anomalous may be difficult to determine with cases approaching a boundary and based on the specific application. For example, small variations may trigger an identification of an anomaly in the data while relatively larger deviations may be considered normal in less sensitive applications. The disclosed systems and methods may provide solutions for detecting anomalies to more accurately and quickly determine whether a model needs to be retrained. If data would be inapplicable or would corrupt the model by reducing the quality of the input data or training process (e.g., due to missing values, outliers, inconsistent formatting, incorrect labels, noisy data, etc.) that data may be automatically dropped and the source of that data may be blocked from providing data that would be used to train the model. This reflects an improvement in the process of training and deploying a model that is accurate and specific to the type of prediction sought. In particular, this provides an improvement in the field of model training, which provides a practical application.

In other applications, the anomaly detections processes described herein may be used to provide enhanced security to the overall computing system by detecting malicious attacks on network security. For example, the system may take proactive measures to remediate danger by detecting the source address associated with potentially malicious packets and dropping potentially malicious packets. This provides an improvement in network security by dropping potentially malicious packets and blocking future traffic from the source address of the potentially malicious source address.

The systems and methods disclosed herein may also be used to analyze text to form the predictions. In particular, the systems and methods described herein include a combination of elements that are utilized in a specific manner for automatically performing automated processes based on technological efficiency, which provides a specific improvement over prior art systems resulting in improved computer processing for faster automated processing functions. For example, the systems and method may apply robotic process automation for digital transformation of the data based on specific criteria to interpret text and unstructured data using text processing software techniques. The interpretation of the text may be implemented using the models described herein including unsupervised learning techniques or supervised learning techniques. The processor may track how much memory and/or processing time has been allocated to perform a function and the system may be trained to automatically detect and identify processes eligible for increased efficiencies based on existing inefficiencies in the process.

For example, the machine learning models may use unsupervised learning to identify and characterize hidden structures of unstructured and unlabeled content data, or supervised techniques that operate on labeled content data and include instructions informing the system which outputs are related to specific input values. In such instances, software processing can rely on iterative training techniques and training data to configure neural networks with an understanding of individual words, phrases, subjects, sentiments, and parts of speech.

Supervised learning software systems are trained using content data that is labeled or “tagged.” During training, the supervised software systems learn the best mapping function between a known data input and expected known output (e.g., labeled or tagged content data). Supervised natural language processing software then uses the best approximating mapping learned during training to analyze unforeseen input data (never seen before) to accurately predict the corresponding output. Supervised learning software systems often require extensive and iterative optimization cycles to adjust the input-output mapping until they converge to an expected and well-accepted level of performance, such as an acceptable threshold error rate between a computed probability and a desired threshold probability.

The software systems are supervised because the way of learning from training data mimics the same process of a teacher supervising the end-to-end learning process. Supervised learning software systems are typically capable of achieving excellent levels of performance, but this excellent level of performance requires labeled data to be available. Developing, scaling, deploying, and maintaining accurate supervised learning software systems can take significant time, resources, and technical expertise from a team of skilled data scientists. Moreover, precision of the systems is dependent on the availability of labeled content data for training that is comparable to the corpus of content data that the system will process in a production environment.

Supervised learning software systems implement techniques that include, without limitation, Latent Semantic Analysis (“LSA”), Probabilistic Latent Semantic Analysis (“PLSA”), Latent Dirichlet Allocation (“LDA”), and more recent Bidirectional Encoder Representations from Transformers (“BERT”). Latent Semantic Analysis software processing techniques process a corporate of content data files to ascertain statistical co-occurrences of words that appear together, which then give insights into the subjects of those words and documents.

Unsupervised learning software systems can perform training operations on unlabeled data and less requirement for time and expertise from trained data scientists. Unsupervised learning software systems can be designed with integrated intelligence and automation to automatically discover information, structure, and patterns from content data. Unsupervised learning software systems can be implemented with clustering software techniques that include, without limitation, K-means clustering, Mean-Shift clustering, Density-based clustering, Spectral clustering, Principal Component Analysis, and Neural Topic Modeling (“NTM”).

Clustering software techniques can automatically group semantically similar words together to accelerate the derivation and verification of an underneath common intent—e.g., ascertain or derive a new classification or subject, and not just classification into an existing subject or classification. Unsupervised learning software systems are also used for association rules mining to discover relationships between features from content data.

The content driver software service utilizes one or more supervised or unsupervised software processing techniques to perform a subject classification analysis to generate subject data. Suitable software processing techniques can include, without limitation, Latent Semantic Analysis, Probabilistic Latent Semantic Analysis, Latent Dirichlet Allocation. Latent Semantic Analysis software processing techniques generally process a corpus of alphanumeric text files, or documents, to ascertain statistical co-occurrences of words that appear together, which then give insights into the subjects of those words and documents. The content driver software service can utilize software processing techniques that include Non-Matrix Factorization, Correlated Topic Model (“CTM”), and K-Means or other types of clustering.

Neural networks may be trained using training set content data that comprise sample tokens, phrases, sentences, paragraphs, or documents for which desired subjects, content sources, interrogatories, or sentiment values are known. A labeling analysis may be performed on the training set content data to annotate the data with known subject labels, interrogatory labels, content source labels, or sentiment labels, thereby generating annotated training set content data. For example, a person can utilize a labeling software application to review training set content data to identify and tag or “annotate” various parts of speech, subjects, interrogatories, content sources, and sentiments.

The training set content data may then be fed to the content driver software service neural networks to identify subjects, content sources, or sentiments and the corresponding probabilities. For example, the analysis might identify that particular text represents a question with a 35% probability. If the annotations indicate the text is, in fact, a question, an error rate can be taken to be 65% or the difference between the computed probability and the known certainty. Then parameters to the neural network are adjusted (e.g., constants and formulas that implement the nodes and connections between node), to increase the probability from 35% to ensure the neural network produces more accurate results, thereby reducing the error rate. The process is run iteratively on different sets of training set content data to continue to increase the accuracy of the neural network.

The content data is first pre-processes using a reduction analysis to create reduced content data. The reduction analysis first performs a qualification operation that removes unqualified content data that does not meaningfully contribute to the subject classification analysis. The qualification operation removes certain content data according to criteria defined by a provider. For instance, the qualification analysis can determine whether content data files are “empty” and contain no recorded linguistic interaction between a provider agent and a user and designate such empty files as not suitable for use in a subject classification analysis. As another example, the qualification analysis can designate files below a certain size or having a shared experience duration below a given threshold (e.g., less than one minute) as also being unsuitable for use in the subject classification analysis.

The reduction analysis can also perform a contradiction operation to remove contradictions and punctuations from the content data. Contradictions and punctuation include removing or replacing abbreviated words or phrases that can cause inaccuracies in a subject classification analysis. Examples include removing or replacing the abbreviations “min” for minute, “u” for you, and “wanna” for “want to,” as well as apparent misspellings, such as “mssed” for the word missed. In some embodiments, the contradictions can be replaced according to a standard library of known abbreviations, such as replacing the acronym “brb” with the phrase “be right back.” The contradiction operation can also remove or replace contractions, such as replacing “we're” with “we are.”

The reduction analysis can also streamline the content data by performing one or more of the following operations, including: (i) tokenization to transform the content data into a collection of words or key phrases having punctuation and capitalization removed; (ii) stop word removal where short, common words or phrases such as “the” or “is” are removed; (iii) lemmatization where words are transformed into a base form, like changing third person words to first person and changing past tense words to present tense; (iv) stemming to reduce words to a root form, such as changing plural to singular; and (v) hyponymy and hypernym replacement where certain words are replaced with words having a similar meaning so as to reduce the variation of words within the content data.

Following a reduction analysis, the reduced content data is vectorized to map the alphanumeric text into a vector form. One approach to vectorizing content data includes applying “bag-of-words” modeling. The bag-of-words approach counts the number of times a particular word appears in content data to convert the words into a numerical value. The bag-of-words model can include parameters, such as setting a threshold on the number of times a word must appear to be included in the vectors.

Techniques to encode the context communication elements (e.g., such as words, speech patterns, tone, timbre, cadence, etc.) may, in part, determine how often communication elements appear together. Determining the adjacent pairing of communication elements can be achieved by creating a co-occurrence matrix with the value of each member of the matrix counting how frequently one communication element coincides with another, either just before or just after it. That is, the words or communication elements form the row and column labels of a matrix, and a numeric value appears in matrix elements that correspond to a row and column label for communication elements that appear adjacent in the content data.

As an alternative to counting communication elements (e.g., words) in a corpus of content data and turning it into a co-occurrence matrix, another software processing technique may be used where a communication element in the content data corpus predicts the next communication element. Looking through a corpus, counts may be generated for adjacent communication elements, and the counts are converted from frequencies into probabilities (e.g., using n-gram predictions with Kneser-Ney smoothing) using a simple neural network. Suitable neural network architectures for such purpose include a skip-gram architecture. The neural network may be trained by feeding through a large corpus of content data, and embedded middle layers in the neural network are adjusted to best predict the next word.

The predictive processing creates weight matrices that densely carry contextual, and hence semantic, information from the selected corpus of content data. Pre-trained, contextualized content data embedding can have high dimensionality. To reduce the dimensionality, a uniform manifold approximation and projection algorithm (“UMAP”) can be applied to reduce dimensionality while maintaining essential information.

Prior to conducting a subject analysis to ascertain subject identifiers in the content data (e.g., topics or subjects addressed in the content data) or interaction driver identifiers in the content data (e.g., reasons why the customer initiated the interaction with the provider, such as the reason underlying a support request), the system can perform a concentration analysis on the content data. The concentration analysis concentrates, or increases the density of, the content data by identifying and retaining communication elements that have significant weight in the subject analysis and discarding or ignoring communication elements that have relatively little weight.

In one embodiment, the concentration analysis includes executing a term frequency-inverse document frequency (“tf-idf”) software processing technique to determine the frequency or corresponding weight quantifier for communication elements with the content data. The weight quantifiers are compared against a pre-determined weight threshold to generate concentrated content data that is made up of communication elements having weight quantifiers above the weight threshold.

The concentrated content data is processed using a subject classification analysis to determine subject identifiers (e.g., topics) addressed within the content data. The subject classification analysis can specifically identify one or more interaction driver identifiers that are the reason why a user initiated a shared experience or support service request. An interaction driver identifier can be determined by, for example, first determining the subject identifiers having the highest weight quantifiers (e.g., frequencies or probabilities) and comparing such subject identifiers against a database of known interaction driver identifiers.

In one embodiment, the subject classification analysis is performed on the content data using a Latent Dirichlet Allocation analysis to identify subject data that includes one or more subject identifiers (e.g., topics addressed in the underlying content data). Performing the LDA analysis on the reduced content data may include transforming the content data into an array of text data representing key words or phrases that represent a subject (e.g., a bag-of-words array) and determining the one or more subjects through analysis of the array. Each cell in the array can represent the probability that given text data relates to a subject. A subject is then represented by a specified number of words or phrases having the highest probabilities (e.g., the words with the five highest probabilities), or the subject is represented by text data having probabilities above a predetermined subject probability threshold.

Clustering software processing techniques include K-means clustering, which is an unsupervised processing technique that does not utilize labeled content data. Clusters are defined by “K” number of centroids where each centroid is a point that represents the center of a cluster. The K-means processing technique run in an iterative fashion where each centroid is initially placed randomly in the vector space of the dataset, and the centroid moves to the center of the points that is closest to the centroid. In each new iteration, the distance between each centroid and the points are recomputed, and the centroid moves again to the center of the closest points. The processing completes when the position or the groups no longer change or when the distance in which the centroids change does not surpass a pre-defined threshold.

The clustering analysis yields a group of words or communication elements associated with each cluster, which can be referred to as subject vectors. Subjects may each include one or more subject vectors where each subject vector includes one or more identified communication elements (e.g., keywords, phrases, symbols, etc.) within the content data as well as a frequency of the one or more communication elements within the content data. The content driver software service can be configured to perform an additional concentration analysis following the clustering analysis that selects a pre-defined number of communication elements from each cluster to generate a descriptor set, such as the five or ten words having the highest weights in terms of frequency of appearance (or in terms of the probability that the words or phrases represent the true subject when neural networking architecture is used). In one embodiment, the descriptor sets were analyzed to determine if the reasons driving a customer support request were identified by the descriptor set subject identifiers.

The software model may be evaluated according to three categories, including a “good match” where the support request reason(s) are identified by the top words in the subject vector (e.g., the words with the highest weight or frequency), a “moderate” match where the support request reason(s) are identified by the second tier of words in the subject vector (e.g., words six to ten), and a “poor” match where, for instance, the top words in a subject vector do not match or identify the reasons the support request was initiated.

Alternatively, instead of selecting a pre-determined number of communication elements, post-clustering concentration analysis can analyze the subject vectors to identify communication elements that are included in several subject vectors having a weight quantifier (e.g., a frequency) below a specified weight threshold level that are then removed from the subject vectors. In this manner, the subject vectors are refined to exclude content data less likely to be related to a given subject. To reduce an effect of spam, the subject vectors may be analyzed, such that if one subject vector is determined to include communication elements that are rarely used in other subject vectors, then the communication elements are marked as having a poor subject correlation and is removed from the subject vector.

In another embodiment, the concentration analysis is performed on unclassified content data by mapping the communication elements within the content data to integer values. The content data is thus turned into a bag-of-words that includes integer values and the number of times the integers occur in content data. The bag-of-words is turned into a unit vector, where all the occurrences are normalized to the overall length. The unit vector may be compared to other subject vectors produced from an analysis of content data by taking the dot product of the two-unit vectors. All the dot products for all vectors in a given subject are added together to provide a weighting quantifier or score for the given subject identifier, which is taken as subject weighting data. A similar analysis can be performed on vectors created through other processing, such as K-means clustering or techniques that generate vectors where each word in the vector is replaced with a probability that the word represents a subject identifier or request driver data.

To illustrate generating subject weighting data, for any given subject there may be numerous subject vectors. Assume that for most of subject vectors, the dot product will be close to zero—even if the given content data addresses the subject at issue. Since there are some subjects with numerous subject vectors, there may be numerous small dot products that are added together to provide a significant score. Put another way, the particular subject is addressed consistently throughout a document, several documents, sessions of the content data, and the recurrence of the carries significant weight.

In another embodiment, a predetermined threshold may be applied where any dot product that has a value less than the threshold is ignored and only stronger dot products above the threshold are summed for the score. In another embodiment, this threshold may be empirically verified against a training data set to provide a more accurate subject analysis.

In another example, a number of subject identifiers may be substantially different, with some subjects having orders of magnitude fewer subject vectors than do other subjects. The weight scoring might significantly favor relatively unimportant subjects that occur frequently in the content data. To address this problem, a linear scaling on the dot product scoring based on the number of subject vectors may be applied. The result provides a correction to the score so that important but less common subjects are weighed more heavily.

Once all scores are computed for all subjects, then subjects may be sorted, and the most probable subjects are returned. The resulting output provides an array of subjects and strengths. In another embodiment, hashes may be used to store the subject vectors to provide a simple lookup of text data (e.g., words and phrases) and strengths. The one or more subject vectors can be represented by hashes of words and strengths, or alternatively an ordered byte stream (e.g., an ordered byte stream of 4-byte integers, etc.) with another array of strengths (e.g., 4-byte floating-point strengths, etc.).

The content driver software service can also use term frequency-inverse document frequency software processing techniques to vectorize the content data and generating weighting data that weight words or particular subjects. The tf-idf is represented by a statistical value that increases proportionally to the number of times a word appears in the content data. This frequency is offset by the number of separate content data instances that contain the word, which adjusts for the fact that some words appear more frequently in general across multiple shared experiences or content data files. The result is a weight in favor of words or terms more likely to be important within the content data, which in turn can be used to weigh some subjects more heavily in importance than others. To illustrate with a simplified example, the tf-idf might indicate that the term “password” carries significant weight within content data. To the extent any of the subjects identified by a natural language processing analysis include the term “password,” that subject can be assigned more weight by the content driver software service.

The content data can be visualized and subject to a reduction into two-dimensional data using a UMAP to generate a cluster graph visualizing a plurality of clusters. The content driver software service feeds the two-dimensional data into a DBSCAN and identify a center of each cluster of the plurality of clusters. The process may, using the two dimensional data from the UMAP and the center of each cluster from the DBSCAN, apply a KNN to identify data points closest to the center of each cluster and shade each of the data points to graphically identify each cluster of the plurality of clusters. The processor may illustrate a graph on the display representative of the data points that are shaded following application of the KNN.

The content driver software service can also incorporate Part of Speech (“POS”) tagging software code that assigns words a part of speech depending upon the neighboring words, such as tagging words as a noun, pronoun, verb, adverb, adjective, conjunction, preposition, or other relevant parts of speech. The content driver software service can utilize the POS tagged words to help identify questions and subjects according to pre-defined rules, such as recognizing that the word “what” followed by a verb is also more likely to be a question than the word “what” followed by a preposition or pronoun (e.g., “What is this?” versus “What he wants is an answer.”).

POS tagging in conjunction with Named Entity Recognition (“NER”) software processing techniques can be used by the content driver software service to identify various content sources within the content data. NER techniques are utilized to classify a given word into a category, such as a person, product, organization, or location. Using POS and NER techniques to process the content data allow the content driver software service to identify particular words and text as a noun and as representing a person participating in the discussion (e.g., a content source).

In instances where audio signals are being interpretated from audio files, video files, continual audio inputs (e.g., via a microphone), the system may apply binary time-frequency masks to separate signals from multiple sources by using a binary matrix to indicate which portions of a representation should be turned on or off. A binary mask includes a matrix of binary values that correspond to sources such that it is multiplied with a spectrogram to include or exclude portions of the audio. The binary time-frequency mask for each speaker or audio source is obtained using clustering that assigns the number “1” to all time-frequency bins corresponding to the respective speaker and assigning the number “0” to the remaining time-frequency bins. Inverse short time Fourier transform (STFT) may convert the obtained separated signals into a time domain for multiple downstream applications. Speech waveforms may be synthesized from the masked clusters where each waveform corresponds to a different source of the audio. Further, the speech waveforms may be combined to generate a mixed speech signal by stitching together the speech waveforms corresponding to the different sources. Advantageously, this process can be used to remove certain voices or background conversations from a recording where there are multiple sources of audio. Synthesizing speech waveforms from a cluster of numbers is not a process that can be practically performed in the human mind. By combining speech waveforms to generate a mixed speech signal by stitching together speech waveforms corresponding to different sources and excluding the sources that are undesired as either being undesired voices or background conversations. Advantageously, this can be used to isolate a desired source of audio as part of computer-based separation techniques to distinguish audio from different users. This can help the system accurately interpret the most relevant information to perform further analysis on the speech of the desired source of the audio.

The systems and methods disclosed herein may utilize deployed models 110 and/or AI assistant application 108 (e.g., machine learning models, large language models, neural networks, predictive models, etc.) to make predictions about user queries. The use of specially trained models realizes a number of improvements over traditional methods of processing user queries, including more accurate responses to user queries. Further, the systems and methods disclosed herein lead to faster training times and a more accurate model.

The systems and methods disclosed herein reflect an improvement in the functioning of a computer or an improvement to other technology or a technical field by leveraging data ingestion and curation to ensure that only relevant and appropriate information is used for training the models 110 and/or when the models 110 generate responses to queries based on the training.

In addition, the systems and methods utilize a particular machine or manufacture such as, for example, computing devices 102 and/or user devices 104. The computing devices 102 and/or user devices 104 are integral to effectuating the improvements disclosed herein by training and/or deploying trained models 110, including via the AI assistant application 108. Further, the systems and methods disclosed herein utilize a combination of software and hardware that include, for example, a physical circuit, which is a machine or manufacture.

FIG. 17 illustrates an example computing system 1700 suitable for implementing various embodiments as described herein. As shown, the computing system 1700 comprises a computer 1702, which is representative of any type of physical and/or virtualized computing device. Examples of the computer 1702 include, but are not limited to, a server, workstation, laptop, mobile device, smartphone, tablet computer, mainframe, distributed computing system, compute cluster, media device, camera, gaming device, a portable digital assistant (PDA), a system-on-chip (SoC), a pager, a television, a wearable device, a virtual machine (VM), container, or any other device with processing capabilities. In one embodiment, the computer 1702 is representative of some or all of the components of the system 100, including the computing devices 102, user devices 104, data sources 116, and/or event systems 122. More generally, the computing system 1700 is configured to implement all systems, methods, apparatuses, media, and embodiments disclosed herein.

As shown, the computer 1702 includes one or more processors 1704, one or more memories 1706, one or more non-transitory storage media 1710, one or more communications interfaces 1712, one or more positioning devices 1714, one or more input devices 1716, and one or more output devices 1718 communicably coupled via an interconnect 1708. A power source 1720, such as a power supply, battery, or any type of power source may provide power to the computer 1702.

The processor 1704 is representative of any type of processing circuit. For example, the processor 1704 may be a central processing unit (CPU), a microprocessor, a graphics processing unit (GPU), a microcontroller, an application-specific integrated circuit (ASIC), a programmable logic device (PLD), a digital signal processor (DSP), a field programmable gate array (FPGA), a state machine, a controller, gated or transistor logic, a digital signal processor, analog to digital converter, digital to analog converter, and the like.

The memory 1706 is representative of any computer readable medium to store data, code, or other information. The memory 1706 may include volatile memory, such as volatile Random Access Memory (RAM) including a cache area for the temporary storage of data. The memory 1706 may also include non-volatile memory, which can be embedded and/or may be removable. The non-volatile memory can additionally or alternatively include an electrically erasable programmable read-only memory (EEPROM), flash memory or the like. The storage medium 1710 is representative of any type of computer readable medium to store data, code, or other information. Examples of storage media 1710 include solid state drives, hard drives, Redundant Array of Independent Disks (RAID) drives, memory pools, universal serial bus (USB) storage devices, and the like.

The memory 1706 and storage medium 1710 can store any number and type of computer-executable instructions executed by the processor 1704 to implement the functions of the computer 1702 described herein. For example, the memory 1706 may include such applications as a web browser application and/or a mobile P2P payment system client application. These applications also typically provide a graphical user interface (GUI) on a display that allows the user to communicate with the computer 1702, and, for example a mobile banking system, and/or other devices or systems. In one embodiment, when the user decides to enroll in a mobile banking program, the user downloads or otherwise obtains the mobile banking system client application from a mobile banking system, or from a distinct application server. In other embodiments, the user interacts with a mobile banking system via a web browser application in addition to, or instead of, the mobile P2P payment system client application. Similarly, the memory 1706 and/or storage medium 1710 may be used to store data such as cached data, files for user accounts, user profiles, account balances, transaction histories, files downloaded or received from other devices, and any other data items.

The interconnect 1708 is representative of any type of circuitry to connect the components of the computer 1702. For example, the interconnect 1708 can include or represent, a system bus, a USB interface, a peripheral component interconnect (PCI), a Peripheral Component Interconnect-enhanced (PCIe), compute express link (CXL) interconnects, Universal Chiplet Interconnect Express (UCIe) interface, PCI-UCIe interconnects, an interface serial peripheral interconnects (SPIs), integrated interconnects (I2Cs), a high-speed interface connecting the processor 1704 to the memory 1706, individual electrical connections among the components, and electrical conductive traces on a motherboard common to some or all of the above-described components of the computer 1702. As discussed herein, the interconnect 1708 may operatively couple various components with one another, or in other words, electrically connects those components, either directly or indirectly-by way of intermediate component(s)—with one another.

The one or more input devices 1716 are representative of any type of input device for receiving input, such as a keypad, keyboard, touchscreen, touchpad, microphone, camera, fingerprint sensor, mouse, joystick, other pointer device, button, soft key, and the like. The one or more output devices 1718 are representative of any type of device for outputting information, such as a monitor, speaker, haptic feedback module, printer, and the like.

The computer 1702 may use the communications interface 1712 to communicate with one or more other devices 1724 via a network 1722. The communications interface 1712 allows the computer 1702 to communicate with and conduct transactions with other devices and systems, such as the other devices 1724. The communications interface 1712 may be a wired and/or a wireless interface. Communications may be conducted via various modes or protocols, of which Global System for Mobile Communications (GSM) voice calls, Short Message Service (SMS), Enhanced Messaging Service (EMS), Multimedia Messaging Service (MMS) messaging, Time Division Multiple Access (TDMA), Code Division Multiple Access (CDMA), Personal Digital Cellular (PDC), Wideband Code Division Multiple Access (WCDMA), CDMA2000, and General Packet Radio Service (GPRS), are all non-limiting and non-exclusive examples. Thus, communications can be conducted, for example, via the wireless communications interface 1712, which can be or include a radio-frequency transceiver, a Bluetooth device, Wi-Fi device, a Near-Field Communication (NFC) device, and other wireless transceivers. In addition, a positioning device 1714 such as a Global Positioning System (GPS) device may be included for navigation and location-related data exchanges, ingoing and/or outgoing. For example, by receiving location information from the positioning device 1714, the AI assistant application 108 may generate navigation instructions.

Wi-Fi networks use radio technologies such as the Institute of Electrical and Electronics Engineers (IEEE) 802.11x (a, b, g, n, ac, ax, etc.) to provide secure, reliable, fast wireless connectivity. A Wi-Fi network connects computers to each other, to the Internet, and to wired networks (which use IEEE 802.3-related media and functions). A Wi-Fi network connects computers to each other, to the Internet, and to wired networks (which use IEEE 802.3-related media and functions). Communications may also and/or alternatively be conducted via wired connections using the communications interface 1712, e.g., using USB, Ethernet, and other physically connected modes of data transfer. The network 1722 may be any one of, or the combination of, wired and/or wireless networks including without limitation a direct connection, a private network (e.g., an intranet), a public network (e.g., the Internet), a Personal Area Network (PAN), a Local Area Network (LAN), a Wide Area Network (WAN), a wireless network, a cellular network, and other communications networks.

The computer 1702 is configured to use the communications interface 1712 as, for example, a network interface to communicate with one or more other devices on a network such as network 1722. In this regard, the computer 1702 utilizes the wireless communications interface 1712 as an antenna operatively coupled to a transmitter and a receiver (together a “transceiver”) included with the communications interface 1712. The communications interface 1712 is configured to provide signals to and receive signals from the transmitter and receiver, respectively. The signals may include signaling information in accordance with the air interface standard of the applicable cellular system of a wireless telephone network. In this regard, the computer 1702 may be configured to operate with one or more air interface standards, communication protocols, modulation types, and access types. By way of illustration, the computer 1702 may be configured to operate in accordance with any of a number of first, second, third, fourth, fifth-generation communication protocols and/or the like. For example, the as a smartphone, the computer 1702 be configured to operate in accordance with second-generation (2G) wireless communication protocols IS-136 (time division multiple access (TDMA)), GSM (global system for mobile communication), and/or IS-95 (code division multiple access (CDMA)), or with third-generation (3G) wireless communication protocols, such as Universal Mobile Telecommunications System (UMTS), CDMA2000, wideband CDMA (WCDMA) and/or time division-synchronous CDMA (TD-SCDMA), with fourth-generation (4G) wireless communication protocols such as Long-Term Evolution (LTE), fifth-generation (5G) wireless communication protocols, Bluetooth Low Energy (BLE) communication protocols such as Bluetooth 5.0, ultra-wideband (UWB) communication protocols, and/or the like. The computer 1702 may also be configured to operate in accordance with non-cellular communication mechanisms, such as via a wireless local area network (WLAN) or other communication/data networks.

The communications interface 1712 may also include a payment network interface. The payment network interface may include software, such as encryption software, and hardware, such as a modem, for communicating information to and/or from one or more devices on a network. For example, the computer 1702 may be configured so that it can be used as a credit or debit card by, for example, wirelessly communicating account numbers or other authentication information to a terminal of the network. Such communication could be performed via transmission over a wireless communication protocol such as the NFC protocol.

The computer 1702 may be under the control of any suitable operating system (not pictured). Example operating systems include, but are not limited to, Linux® operating systems, UNIX®, Windows® operating systems, macOS®, iOS®, Android® and any other type of operating system.

The computer 1702 as illustrated diagrammatically represents at least one example of a possible implementation, where alternatives, additions, and modifications are possible for performing some or all of the described methods, operations, and functions. Although shown separately, in some embodiments, two or more computers 1702, systems, servers, or illustrated components may be utilized. In some implementations, the functions of one or more systems, servers, or illustrated components may be provided by a single system or server. In some embodiments, the functions of one illustrated system or server may be provided by multiple systems, servers, or computing devices, including those physically located at a central facility, those logically local, and those located as remote with respect to each other.

Aspects of the present disclosure are described herein with reference to flowchart illustrations and/or block diagrams of computer-implemented methods and computing systems according to embodiments of the disclosure. It will be understood that each block of the flowchart illustrations and/or block diagrams, and combinations of blocks in the flowchart illustrations and/or block diagrams, can be implemented by computer readable program instructions that may be provided to a processor of a computer or other programmable data processing apparatus (the term “apparatus” includes systems and computer program products). The processor may execute the computer readable program instructions thereby creating a means for implementing the actions specified in the flowchart illustrations and/or block diagrams. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the actions specified in the flowchart illustrations and/or block diagrams. In particular, the computer readable program instructions may be used to produce a computer-implemented method by executing the instructions to implement the actions specified in the flowchart illustrations and/or block diagrams.

The computer program instructions may also be stored in a computer-readable memory that can direct a computer or other programmable data processing apparatus to function in a particular manner, such that the instructions stored in the computer readable memory produce an article of manufacture including instructions, which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions, which execute on the computer or other programmable apparatus, provide steps for implementing the functions/acts specified in the flowchart and/or block diagram block or blocks. Alternatively, computer program implemented steps or acts may be combined with operator or human implemented steps or acts to carry out an embodiment.

In the flowchart illustrations and/or block diagrams disclosed herein, each block in the flowchart/diagrams may represent a module, segment, or portion of instructions, which comprises one or more executable instructions for implementing the specified logical function(s). In some implementations, the functions noted in the blocks may occur out of the order noted in the Figures. For example, two blocks shown in succession may, in fact, be executed substantially concurrently, or the blocks may sometimes be executed in the reverse order, depending upon the functionality involved.

Computer program instructions are configured to carry out operations of the present disclosure and may be or may incorporate assembler instructions, instruction-set-architecture (ISA) instructions, machine instructions, machine dependent instructions, microcode, firmware instructions, state-setting data, source code, and/or object code written in any combination of one or more programming languages.

An application program may be deployed by providing computer infrastructure operable to perform one or more embodiments disclosed herein by integrating computer readable code into a computing system thereby performing the computer-implemented methods disclosed herein.

Although various computing environments are described above, these are only examples that can be used to incorporate and use one or more embodiments. Many variations are possible.

The terminology used herein is for the purpose of describing particular embodiments only and is not intended to be limiting of the disclosure. As used herein, the singular forms “a”, “an” and “the” are intended to include the plural forms as well, unless the context clearly indicates otherwise. It will be further understood that the terms “comprise” (and any form of comprise, such as “comprises” and “comprising”), “have” (and any form of have, such as “has” and “having”), “include” (and any form of include, such as “includes” and “including”), and “contain” (and any form contain, such as “contains” and “containing”) are open-ended linking verbs. As a result, a method or device that “comprises”, “has”, “includes” or “contains” one or more steps or elements possesses those one or more steps or elements, but is not limited to possessing only those one or more steps or elements. Likewise, a step of a method or an element of a device that “comprises”, “has”, “includes” or “contains” one or more features possesses those one or more features, but is not limited to possessing only those one or more features. Furthermore, a device or structure that is configured in a certain way is configured in at least that way, but may also be configured in ways that are not listed.

The corresponding structures, materials, acts, and equivalents of all means or step plus function elements in the claims below, if any, are intended to include any structure, material, or act for performing the function in combination with other claimed elements as specifically claimed. The description of the present disclosure has been presented for purposes of illustration and description, but is not intended to be exhaustive or limited to the disclosure in the form disclosed. Many modifications and variations will be apparent to those of ordinary skill in the art without departing from the scope and spirit of the disclosure. The embodiment was chosen and described to explain the principles of one or more aspects of the disclosure and the practical application, and to enable others of ordinary skill in the art to understand one or more aspects of the disclosure for various embodiments with various modifications as are suited to the particular use contemplated.

What is claimed is:

1. A method to provide an artificial intelligence assistant for constraint-based response generation, comprising:
receiving, by a processor, a request from a device, the request associated with an event at a physical location;
processing, by a large language model, the request to determine an intent associated with the request;
generating, by the large language model based on the intent and one or more constraints, a response comprising information related to the event;
returning, by the processor, the response to the device.

2. The method of claim 1, wherein the event comprises one or more of: (i) a sporting event at the physical location, (ii) a concert at the physical location, (iii) a conference at the physical location, or (iv) a meeting at the physical location.

3. The method of claim 1, wherein the constraints comprise: (i) approved topics, (ii) restricted topics, (iii) approved data types, (iv) restricted data types, (v) approved responses, and (vi) restricted responses.

4. The method of claim 1, further comprising prior to generating the response:
extracting, by the large language model, one or more attributes of the request.

5. The method of claim 4, wherein the large language model further generates the response based on the determined attributes of the request.

6. The method of claim 1, wherein the large language model is trained based on training data received from a plurality of data sources.

7. The method of claim 6, wherein the plurality of data sources comprise: (i) websites, (ii) data sources associated with a plurality of events including the event, (iii) data sources associated with sponsors of the event, and (iv) data sources associated with a plurality of physical locations including the location.

8. The method of claim 7, wherein the large language model is further trained based on a plurality of predetermined intents and a plurality of constraints.

9. The method of claim 1, further comprising:
receiving, by the processor, feedback data; and
retraining, by the processor, the large language model based on the feedback data.

10. The method of claim 1, wherein the request comprises an indication of an accessible location type, wherein the response comprises a plurality of accessible locations of the accessible location type at the physical location.

11. The method of claim 10, further comprising:
receiving, by the processor, input comprising a first accessible location of the plurality of accessible locations;
determining, by the processor, a location of the device; and
generating, by the processor, directions from the location of the device to the first accessible location.

12. The method of claim 1, wherein the event comprises a sporting event, wherein the request comprises an indication a participant at the sporting event.

13. The method of claim 12, wherein the response further comprises information associated with the sporting event and the participant.

14. The method of claim 1, further comprising prior to receiving the request:
receiving, from the device, an indication of a link.

15. The method of claim 14, wherein the link is encoded in a matrix code displayed at the physical location.

16. The method of claim 15, wherein the matrix code is one of a plurality of matrix codes displayed at the physical location.

17. The method of claim 16, wherein the link is directed to a mobile application.

18. The method of claim 1, wherein the link is directed to a website.

19. An apparatus, comprising:
a processor; and
a memory storing instructions that, when executed by the processor, cause the processor to:
receive a request from a device, the request associated with an event at a physical location;
process, by a large language model, the request to determine an intent associated with the request;
generate, by the large language model based on the intent and one or more constraints, a response comprising information related to the event; and
return the response to the device.

20. A non-transitory computer-readable storage medium, the computer-readable storage medium including instructions that when executed by a processor, cause the processor to:
receive a request from a device, the request associated with an event at a physical location;
process, by a large language model, the request to determine an intent associated with the request;
generate, by the large language model based on the intent and one or more constraints, a response comprising information related to the event; and
return the response to t
